(19) United States
(12) Patent Application Publication
(10) Pub. No.: US 2022/0084244 A1
(43) Pub. Date: Mar. 17, 2022

(54) INFORMATION PROCESSING APPARATUS, INFORMATION PROCESSING METHOD, AND PROGRAM

(71) Applicant: Sony Group Corporation, Tokyo (JP)

(72) Inventors: Nobuhiro Tsunashima, Kanagawa (JP); Daisuke Tahara, San Jose, CA (US)

(21) Appl. No.: 17/416,926

(22) PCT Filed: Dec. 27, 2019
(86) PCT No.: PCT/JP2019/051427

§ 371 Date: Jun. 21, 2021

Related U.S. Application Data
(63) Continuation of application No. 16/524,449, filed on Jul. 29, 2019, now abandoned.
(60) Provisional application No. 62/792,002, filed on Jan. 14, 2019.

(51) Int. Cl. G06T 7/80; G01P 15/18; G06T 7/246

(52) U.S. Cl. CPC G06T 7/80; G06T 2207/30196; G06T 7/246; G01P 15/18

(57) ABSTRACT

Provided are a position detection unit configured to detect first position information of a first imaging device and a second imaging device on the basis of a physical characteristic point of a subject imaged by the first imaging device and a physical characteristic point of a subject imaged by a second imaging device, and a position estimation unit configured to estimate a moving amount of the first imaging device and estimate second position information. The physical characteristic point is detected from a joint of the subject. The subject is a person. The present technology can be applied to an information processing apparatus that detects positions of a plurality of imaging devices.

### CROSS-REFERENCE TO RELATED APPLICATION

This application claims the benefit of priority of Provisional Application Ser. No. 62/792,002, filed on Jan. 14, 2019, the entire contents of which is incorporated herein by reference.

### TECHNICAL FIELD

The present technology relates to an information processing apparatus, an information processing method, and a program, and relates to, for example, an information processing apparatus, an information processing method, and a program for calculating, when a plurality of imaging devices is installed, positions where the imaging devices are installed.

### BACKGROUND ART

In a case of capturing the same object, scene, or the like by a plurality of imaging devices to acquire three-dimensional information of a capturing target, there is a method of calculating distances from the respective imaging devices to the target, using a difference in how the target captured by each of the plurality of imaging devices looks in each of the imaging devices.

In the case of acquiring three-dimensional information by this method, it is necessary that a positional relationship among the plurality of imaging devices used for capturing is known. Obtaining the positional relationships among the imaging devices may be referred to as calibration in some cases.

As a calibration method, the positional relationship among the imaging devices is calculated by using a board called special calibration board on which a pattern of fixed shape and size is printed, capturing the calibration board by the plurality of imaging devices at the same time, and performing an analysis using images captured by the imaging devices.

Calibration methods not using the calibration board have also been proposed. PTL 1 has proposed detecting a plurality of positions of the head and the foot of a person on a screen in chronological order while moving the person, and performing calibration from detection results.

### CITATION LIST

### Patent Literature

[PTL 1]
Japanese Patent Application Laid-Open No. 2011-215082

### SUMMARY

### Technical Problem

In the case of performing calibration using the special calibration board, the calibration cannot be performed without the calibration board, and thus the calibration board needs to be prepared in advance and a user is required to take a trouble with preparing the calibration board.

Furthermore, in a case where the position of the imaging device is changed for some reason after the positions of the plurality of imaging devices are obtained, calibration using the calibration board needs to be performed again in order to update the changed position, and easy modification of the changed position has been difficult.

Furthermore, in the method according to PTL 1, there are various conditions such as a person standing perpendicular to the ground, and the ground being within an imaging range of the imaging device, and there is a possibility of reduction in usability.

The present technology has been made in view of the foregoing, and is intended to easily obtain positions of a plurality of imaging devices.

### Solution to Problem

An information processing apparatus according to one aspect of the present technology includes a position detection unit configured to detect first position information of a first imaging device and a second imaging device on the basis of a physical characteristic point of a subject imaged by the first imaging device and a physical characteristic point of a subject imaged by a second imaging device, and a position estimation unit configured to estimate a moving amount of the first imaging device and estimate second position information. An information processing method according to one aspect of the present technology includes, by an information processing apparatus that detects a position of an imaging device, detecting first position information of a first imaging device and a second imaging device on the basis of a physical characteristic point of a subject imaged by the first imaging device and a physical characteristic point of a subject imaged by a second imaging device, and estimating a moving amount of the first imaging device and estimating second position information.

A program according to one aspect of the present technology causes a computer to execute processing of detecting first position information of a first imaging device and a second imaging device on the basis of a physical characteristic point of a subject imaged by the first imaging device and a physical characteristic point of a subject imaged by a second imaging device, and estimating a moving amount of the first imaging device and estimating second position information.

In an information processing apparatus, an information processing method, and a program according to one aspect of the present technology, first position information of a first imaging device and a second imaging device is detected on the basis of a physical characteristic point of a subject imaged by the first imaging device and a physical characteristic point of a subject imaged by a second imaging device, and second position information is estimated as a moving amount of the first imaging device is estimated.

Note that the information processing apparatus may be an independent apparatus or may be internal blocks configuring one apparatus.

Furthermore, the program can be provided by being transmitted via a transmission medium or by being recorded on a recording medium.

### BRIEF DESCRIPTION OF DRAWINGS

FIG. 1 is a diagram illustrating a configuration of an embodiment of an information processing system to which an embodiment of the present technology is applied.

FIG. 2 is a diagram illustrating a configuration example of an imaging device.

FIG. 3 is a diagram illustrating a configuration example of an information processing apparatus.

FIG. 4 is a diagram illustrating a functional configuration example of the information processing system.

FIG. 5 is a diagram illustrating a configuration of an information processing apparatus according to a first embodiment.

FIG. 6 is a flowchart for describing an operation of the information processing apparatus according to the first embodiment.

FIG. 7 is a diagram for describing how to calculate external parameters.

FIG. 8 is a diagram illustrating an example of a positional relationship between imaging devices.

FIG. 9 is a diagram for describing physical characteristic points.

FIG. 10 is a diagram for describing integration of position information.

FIG. 11 is a diagram for describing external parameter verification.

FIG. 12 is a diagram illustrating a configuration of an information processing apparatus according to a second embodiment.

FIG. 13 is a flowchart for describing an operation of the information processing apparatus according to the second embodiment.

### DESCRIPTION OF EMBODIMENTS

Hereinafter, modes for implementing the present technology (hereinafter referred to as embodiments) will be described.

### <Configuration of Information Processing System>

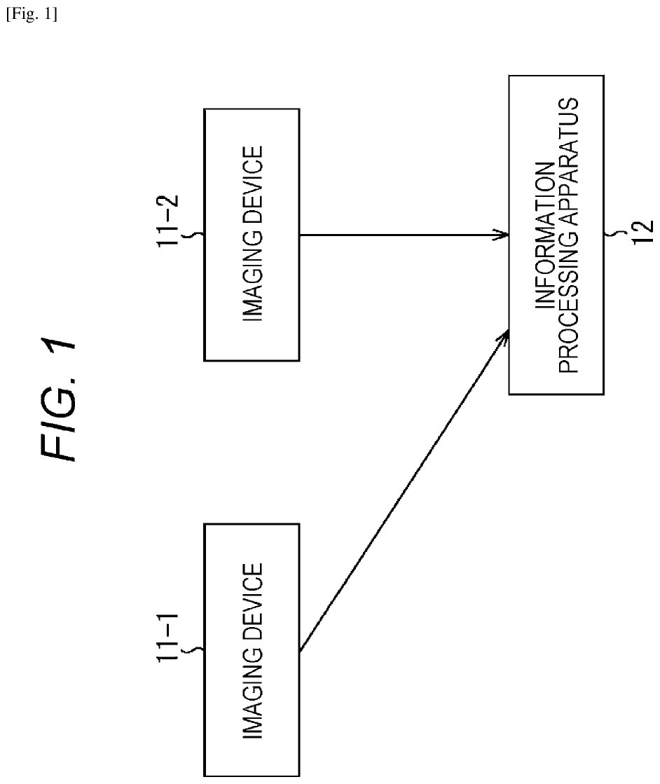

FIG. 1 is a diagram illustrating a configuration of an embodiment of an information processing system to which an embodiment of the present technology is applied. The present technology can be applied to when obtaining, in a case where a plurality of imaging devices is installed, positions where the imaging devices are installed.

Furthermore, the present technology can also be applied to a case where the positions of the plurality of imaging devices change.

The information processing system illustrated in FIG. 1 has a configuration provided with two imaging devices of imaging devices 11-1 and 11-2 and an information processing apparatus 12. In the following description, in a case where it is not necessary to individually distinguish the imaging devices 11-1 and 11-2, the imaging devices 11-1 and 11-2 are simply described as imaging device 11. Further, here, the description will be continued using the case where two imaging devices 11 are installed as an example. However, the present technology can be applied to a case where at least two imaging devices 11 are provided and can also be applied to a case where three or more imaging devices 11 are provided.

The imaging device 11 has a function to image a subject. Image data including the subject imaged by the imaging device 11 is supplied to the information processing apparatus 12. The information processing apparatus 12 obtains a positional relationship between the imaging devices 11-1 and 11-2 by analyzing the image.

The imaging device 11 and the information processing apparatus 12 are configured to be able to exchange the image data. The imaging device 11 and the information processing apparatus 12 are configured to be able to exchange data with each other via a network configured by wired and/or wireless means.

The imaging device 11 captures a still image and a moving image. In the following description, an image indicates images of one frame configuring a still image or a moving image imaged by the imaging device 11.

In a case of performing geometric processing or the like, for example, three-dimensional measurement of the subject, for the images captured by the plurality of imaging devices 11, calibration for obtaining external parameters among the imaging devices 11 needs to be performed.

Furthermore, various applications such as free viewpoint video can be realized by obtaining a fundamental matrix configured by the external parameters without obtaining the external parameters.

The information processing apparatus 12 included in the information processing system can perform such calibration and obtain such a fundamental matrix.

Hereinafter, the description will be continued using the case where the information processing apparatus 12 performs calibration and obtains the fundamental matrix as an example.

### <Configuration Example of Imaging Device>

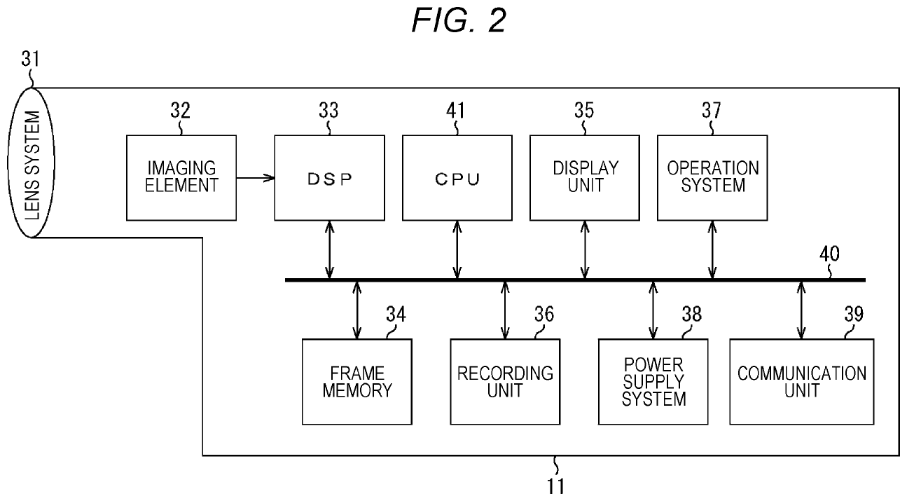

FIG. 2 is a diagram illustrating a configuration example of the imaging device 11. The imaging device 11 includes an optical system including a lens system 31 and the like, an imaging element 32, a DSP circuit 33 that is a camera signal processing unit, a frame memory 34, a display unit 35, a recording unit 36, an operation system 37, a power supply system 38, and a communication unit 39, and the like.

In addition, the DSP circuit 33, the frame memory 34, the display unit 35, the recording unit 36, the operation system 37, the power supply system 38, and the communication unit 39 are mutually connected via a bus line 40. A CPU 41 controls each unit in the imaging device 11.

The lens system 31 takes in incident light (image light) from the subject and forms an image on an imaging surface of the imaging element 32. The imaging element 32 converts a light amount of the incident light imaged on the imaging surface by the lens system 31 into an electrical signal in pixel units and outputs the electrical signal as a pixel signal. As the imaging element 32, an imaging element (image sensor) including pixels described below can be used.

The display unit 35 includes a panel-type display unit such as a liquid crystal display unit or an organic electro luminescence (EL) display unit, and displays a moving image or a still image imaged by the imaging element 32. The recording unit 36 records the moving image or the still image imaged by the imaging element 32 on a recording medium such as a hard disk drive (HDD) or a digital versatile disk (DVD).

The operation system 37 issues operation commands for various functions possessed by the present imaging device under an operation by a user. The power supply system 38 appropriately supplies various power supplies serving as operating power sources for the DSP circuit 33, the frame memory 34, the display unit 35, the recording unit 36, the operation system 37, and the communication unit 39 to these supply targets. The communication unit 39 communicates with the information processing apparatus 12 by a predetermined communication method.

### <Configuration Example of Information Processing Apparatus>

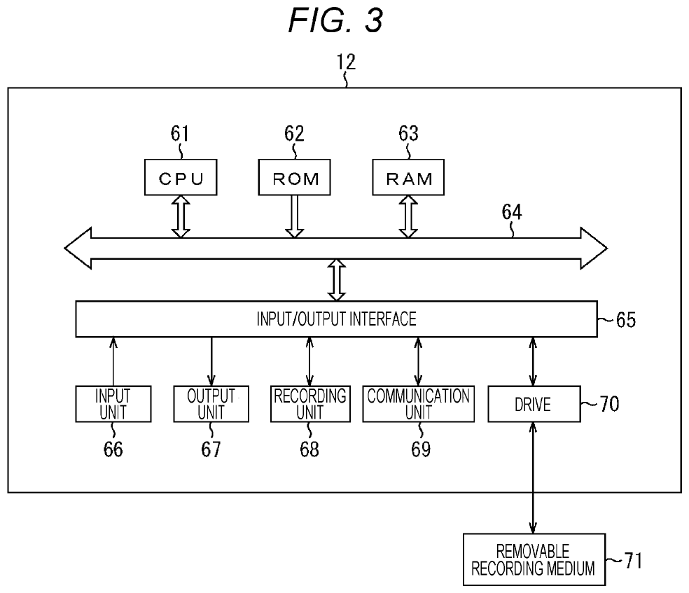

FIG. 3 is a diagram illustrating a configuration example of hardware of the information processing apparatus 12. The information processing apparatus 12 can be configured by, for example, a personal computer. In the information processing apparatus 12, a central processing unit (CPU) 61, a read only memory (ROM) 62, and a random access memory (RAM) 63 are mutually connected by a bus 64. Moreover, an input/output interface 65 is connected to the bus 64. An input unit 66, an output unit 67, a storage unit 68, a communication unit 69, and a drive 70 are connected to the input/output interface 65.

The input unit 66 includes a keyboard, a mouse, a microphone, and the like. The output unit 67 includes a display, a speaker, and the like. The storage unit 68 includes a hard disk, a nonvolatile memory, and the like. The communication unit 69 includes a network interface, and the like. The drive 70 drives a removable recording medium 71 such as a magnetic disk, an optical disk, a magneto-optical disk, or a semiconductor memory.

### <Functions of Information Processing System>

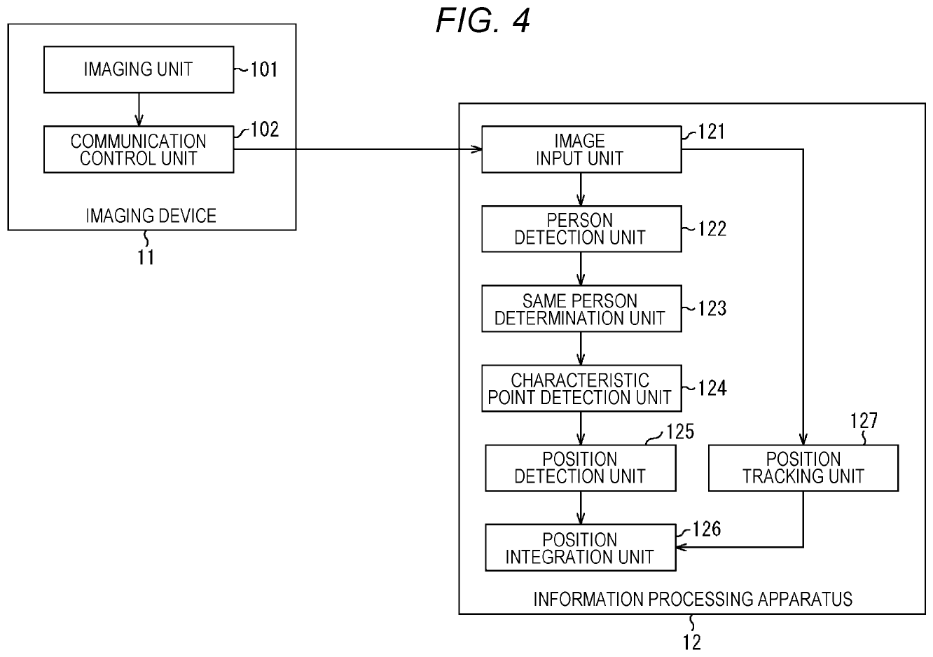

FIG. 4 is a diagram illustrating a configuration example regarding functions of the information processing system. The imaging device 11 includes an imaging unit 101 and a communication control unit 102. The information processing apparatus 12 includes an image input unit 121, a person detection unit 122, a same person determination unit 123, a characteristic point detection unit 124, a position detection unit 125, a position integration unit 126, and a position tracking unit 127.

The imaging unit 101 of the imaging device 11 has a function to control the lens system 31, the imaging element 32, and the like of the imaging device 11 illustrated in FIG. 2 to image the image of the subject. The communication control unit 102 controls the communication unit 39 (FIG. 2) and transmits image data of the image imaged by the imaging unit 101 to the information processing apparatus 12.

The image input unit 121 of the information processing apparatus 12 receives the image data transmitted from the imaging device 11 and supplies the image data to the person detection unit 122 and the position tracking unit 127. The person detection unit 122 detects a person from the image based on the image data. The same person determination unit 123 determines whether or not persons detected from the images imaged by the plurality of imaging devices 11 are the same person.

The characteristic point detection unit 124 detects characteristic points from the person determined to be the same person by the same person determination unit 123, and supplies the characteristic points to the position detection unit 125. As will be described in detail below, physical characteristics of the person, for example, portions such as an elbow and a knee are extracted as the characteristic points.

The position detection unit 125 detects position information of the imaging device 11. As will be described below in detail, the position information of the imaging device 11 indicates relative positions among a plurality of the imaging devices 11 and positions in a real space. The position integration unit 126 integrates the position information of the plurality of imaging devices 11 and specifies positions of the respective imaging devices 11.

The position tracking unit 127 detects the position information of the imaging device 11 by a predetermined method or by a method different from the method of the position detection unit 125.

In the following description, as illustrated in FIG. 1, the description will be continued using the information processing apparatus 12 that processes the information from the two imaging devices 11 as an example.

Furthermore, in embodiments describe below, the description will be continued using a case in which a person is captured as the subject and physical characteristics of the person are detected as an example. However, any subject other than a person can be applied to the present technology as long as the subject is an object from which physical characteristics can be obtained. For example, a so-called mannequin that mimics a shape of a person, a stuffed animal, or the like can be used in place of the above-mentioned person. Furthermore, an animal or the like can be applied to the present technology.

### First Embodiment

As a first embodiment, an information processing apparatus that uses a method of imaging a person, detecting characteristic points from the imaged person, and specifying positions of imaging devices 11 using the detected characteristic points and a method of specifying positions of imaging devices 11 by a self-position estimation technology together will be described.

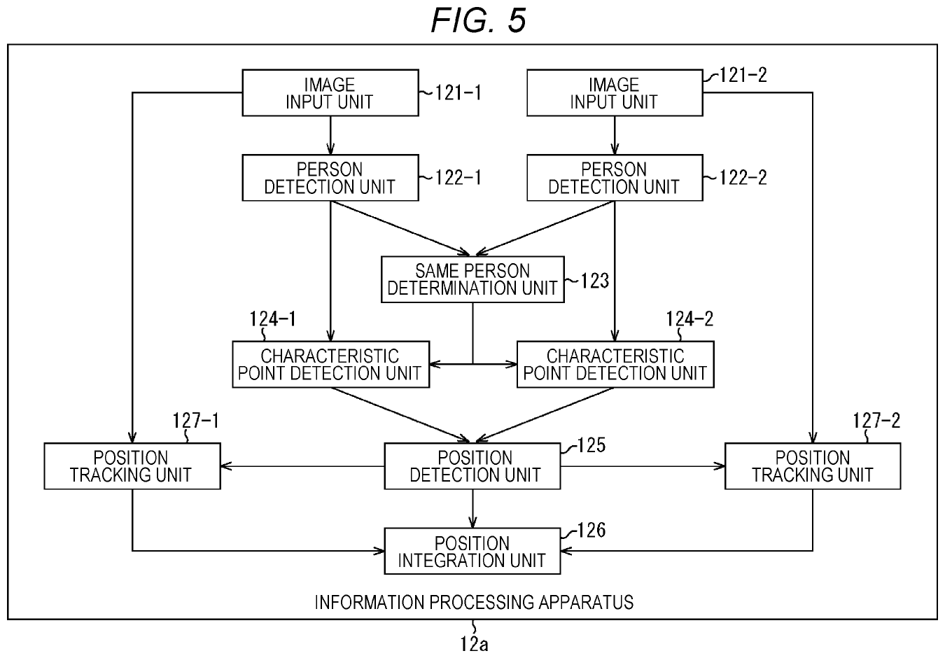

In a case of an information processing apparatus 12 that processes information from the two imaging devices 11, an image input unit 121, a person detection unit 122, a characteristic point detection unit 124, and a position tracking unit 127 are provided for each imaging device 11, as illustrated in FIG. 5. The information processing apparatus 12 according to the first embodiment is described as information processing apparatus 12a.

Referring to FIG. 5, the information processing apparatus 12a includes an image input unit 121-1 that inputs image data from an imaging device 11-1 and an image input unit 121-2 that inputs image data from an imaging device 11-2. The image data input to the image input unit 121-1 is supplied to a person detection unit 122-1 and a position tracking unit 127-1. Likewise, the image data input to the image input unit 121-2 is supplied to the person detection unit 122-2 and the position tracking unit 127-2. The person detection unit 122-1 detects a person from an image based on the supplied image data. Similarly, the person detection unit 122-2 detects a person from an image based on the supplied image data. The person detection unit 122 detects a person, for example, by detecting a face or detecting a characteristic point of a person. In a case where persons are detected, the same person determination unit 123 determines whether or not the persons are the same person.

The same person determination unit 123 determines whether or not the person detected by the person detection unit 122-1 and the person detected by the person detection unit 122-2 are the same person. This determination can be made by specifying a person by face recognition or specifying a person from clothing.

A characteristic point detection unit 124-1 extracts characteristic points from the image imaged by the imaging device 11-1 and supplies the characteristic points to a position detection unit 125 Since the characteristic point is detected from a portion representing a physical characteristic of a person, processing may just be performed only for an image within a region determined by the person detection unit 122-1 as a person. Similarly, a characteristic point detection unit 124-2 extracts characteristic points from the image imaged by the imaging device 11-2 and supplies the characteristic points to the position detection unit 125 Note that, in a case where the person detection unit 122 detects the characteristic points of a person to detect the person, a configuration in which the person detection unit 122 is used as the characteristic point detection unit 124 and the characteristic point detection unit 124 is deleted can be adopted. Furthermore, in a case of imaging one person and detecting the position information, a configuration in which the person detection unit 122 and the same person determination unit 123 are deleted can be adopted.

The characteristic points extracted from the image imaged by the imaging device 11-1 and the characteristic points extracted from the image imaged by the imaging device 11-2 are supplied to the position detection unit 125, and the position detection unit 125 detects relative positions between the imaging device 11-1 and the imaging device 11-2 using the supplied characteristic points. Position information regarding the relative positions between the imaging device 11-1 and the imaging device 11-2 detected by the position detection unit 125-1 is supplied to the position integration unit 126.

The position information is information indicating the relative positions among a plurality of imaging devices 11 and a position in the real space. Furthermore, the position information is an X coordinate, a Y coordinate, and a Z coordinate of the imaging device 11. Furthermore, the position information is a rotation angle around an X axis of the optical axis, a rotation angle around a Y axis of the optical axis, and a rotation angle around a Z axis of the optical axis. The description will be continued on the assumption that the position information includes the aforementioned six pieces of information but the present technology is applicable even in a case where some pieces of information out of the six pieces of information are acquired.

Furthermore, in the above and following description, in a case of giving description such as the position, the position information, or the relative position of the imaging device 11, the description includes not only the position information expressed by the coordinates of the imaging device 11 but also the rotation angles of the optical axis.

The position tracking unit 127-1 functions as a position estimation unit that estimates the position information of the imaging device 11-1, and tracks the position information of the imaging device 11-1 by continuously performing estimation. The position tracking unit 127-1 tracks the imaging device 11-1 by estimating a self-position of the imaging device 11-1 using a technology such as simultaneous localization and mapping (SLAM), for example, and continuing the estimation. Similarly, the position tracking unit 127-2 estimates the position information of the imaging device 11-2, using the technology such as SLAM, for example, to track the imaging device 11-2.

Note that it is not necessary to adopt the configuration to estimate all the position information of the plurality of imaging devices 11, and a configuration to estimate the position information of some imaging devices 11 out of the plurality of imaging devices 11 can be adopted. For example, FIG. 5 illustrates the configuration provided with the position tracking unit 127-1 for estimating the position of the imaging device 11-1 and the position tracking unit 127-2 for estimating the position of the imaging device 11-2 as an example. However, a configuration provided with one position tracking unit 127 that estimates the position information of either the imaging device 11-1 or the imaging device 11-2 can be adopted.

The position information from the position detection unit 125, the position tracking unit 127-1, and the position tracking unit 127-2 is supplied to the position integration unit 126. The position integration unit 126 integrates positional relationships among the plurality of imaging devices 11, in this case, the positional relationship between the imaging device 11-1 and the imaging device 11-2.

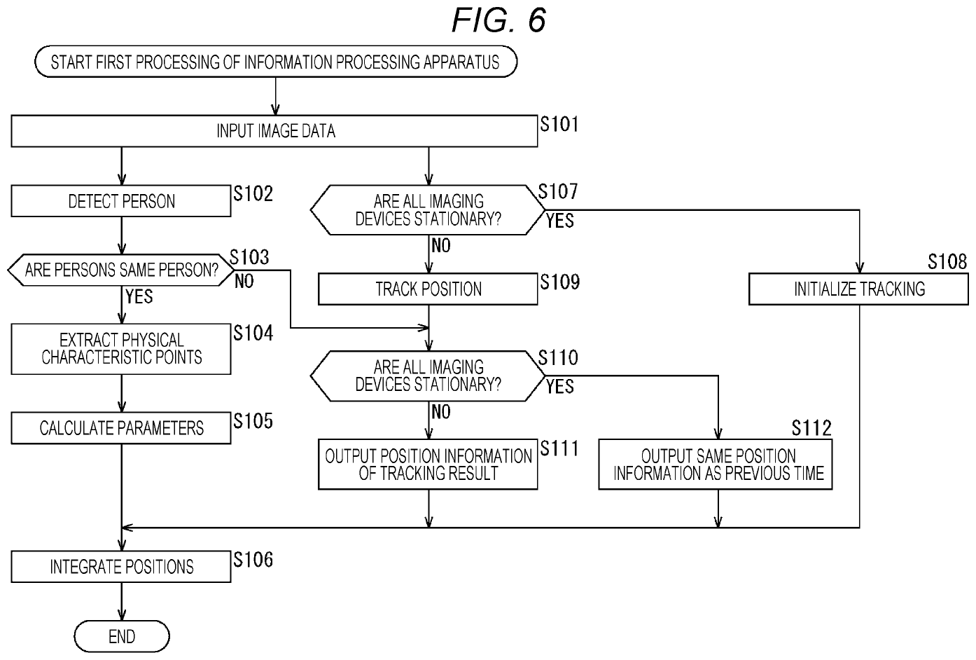

An operation of the information processing apparatus 12a will be described with reference to the flowchart in FIG. 6.

In step S101, the image input unit 121 inputs the image data. The image input unit 121-1 inputs the image data from the imaging device 11-1, and the image input unit 121-2 inputs the image data from the imaging device 11-2. In step S102, the person detection unit 122 detects a person from the image based on the image data input by the image input unit 121. Detection of a person may be performed by specification by a person (a user who uses the information processing apparatus 12a) or may be performed using a predetermined algorithm. For example, the user may operate an input device such as a mouse while viewing the image displayed on a monitor and specify a region where a person appears to detect the person.

Furthermore, the person may be detected by analyzing the image using a predetermined algorithm. As the predetermined algorithm, there are a face recognition technology and a technology for detecting a physical characteristic of a person. Since these technologies are applicable, detailed description of the technologies is omitted here.

In step S102, the person detection unit 122-1 detects a person from the image imaged by the imaging device 11-1 and supplies a detection result to the same person determination unit 123. Furthermore, the person detection unit 122-2 detects a person from the image imaged by the imaging device 11-2 and supplies a detection result to the same person determination unit 123.

In step S103, the same person determination unit 123 determines whether or not the person detected by the person detection unit 122-1 and the person detected by the person detection unit 122-2 are the same person. In a case where a plurality of persons is detected, whether or not the persons are the same person is determined by changing combinations of the detected persons.

In a case where the same person determination unit 123 determines in step S103 that the persons are the same person, the processing proceeds to step S104. In a case where the same person determination unit 123 determines that the persons are not the same person, the processing proceeds to step S110.

In step S104, the characteristic point detection unit 124 detects the characteristic points from the image based on the image data input to the image input unit 121. In this case, since the person detection unit 122 has detected the person from the image, the characteristic points are detected in the region of the detected person. Furthermore, the person to be processed is the person determined to be the same person by the same person determination unit 123. For example, in a case where a plurality of persons is detected, persons not determined to be the same person are excluded from the person to be processed.

The characteristic point detection unit 124-1 extracts the characteristic points from the image imaged by the imaging device 11-1 and input to the image input unit 121-1. The characteristic point detection unit 124-2 extracts the characteristic points from the image imaged by the imaging device 11-2 and input to the image input unit 121-2.

What is extracted as the characteristic point can be a part having a physical characteristic of a person. For example, a joint of a person can be detected as the characteristic point. As will be described below, the position detection unit 125 detects the relative positional relationship between the imaging device 11-1 and the imaging device 11-2 from a correspondence between the characteristic point detected from the image imaged by the imaging device 11-1 and the characteristic point detected from the image imaged by the imaging device 11-2. In other words, the position detection unit 125 performs position detection by combining joint information as the characteristic point detected from one image and joint information as the characteristic point detected from the other image at a corresponding position. In a case where the position detection using such characteristic points is performed, the position information of the imaging device 11 can be obtained regardless of the orientation of the subject, for example, the orientation of the front or the back, and even in a case where a face does not fit within the angle of view, by using the joint information such as a joint of a person as the characteristic point. Physical characteristic points such as eyes and a nose may be of course detected other than the joint of a person. More specifically, a left shoulder, a right shoulder, a left elbow, a right elbow, a left wrist, a right wrist, a neck, a left hip, a right hip, a left knee, a right knee, a left ankle, a right ankle, a right eye, a left eye, a nose, a mouth, a right ear, a left ear, and the like of a person can be detected as the characteristic points. Note that the parts exemplified as the physical characteristics here are examples, and a configuration in which other parts such as a joint of a finger, a fingertip, and a head top may be detected in place of or in addition to the above-described parts can be adopted.

Note that although the parts are described as the characteristic points, the parts may be regions having a certain size or line segments such as edges. For example, in a case where an eye is detected as the characteristic point, a center position of the eye (a center of a black eye) may be detected as the characteristic point, a region of the eye (eyeball) may be detected as the characteristic point, or a boundary (edge) portion between the eyeball and an eyelid may be detected as the characteristic point.

Detection of the characteristic point may be performed by specification by a person or may be performed using a predetermined algorithm. For example, the characteristic point may be detected (set) by a person operating an input device such as a mouse while viewing an image displayed on a monitor, and specifying a portion representing a physical characteristic such as the above-described left shoulder or right shoulder as the characteristic point. In a case of manually detecting (setting) the characteristic point, a possibility of detecting an erroneous characteristic point is low and there is an advantage of accurate detection.

The characteristic point may be detected by analyzing an image using a predetermined algorithm. As the predetermined algorithm, there is an algorithm described in the following document 1, for example, and a technology called OpenPose or the like can be applied.
Document 1: Zhe Cao and Tomas Simon and Shih-En Wei and Yaser Sheikh. Realtime Multi-Person 2D Pose Estimation using Part Affinity Fields. In CVPR, 2017.

The technology disclosed in the document 1 is a technology for estimating a posture of a person, and detects a part (for example, a joint) having a physical characteristic of a person as described above for the posture estimation. Technologies other than the document 1 can also be applied to the present technology, and the characteristic points can be detected by other methods. Simply describing the technology disclosed in the document 1, a joint position is estimated from one image using deep learning, and a confidence map is obtained for each joint. For example, in a case where eighteen joint positions are detected, eighteen confidence maps are generated. Then, posture information of a person can be obtained by joining the joints.

In the characteristic point detection unit 124 (FIG. 5), detection of the characteristic points, in other words, detection of the joint positions is sufficient in this case. Therefore, execution of the processing up to this point is sufficient. Furthermore, information as to whether the detected detection position is a shoulder or an elbow and information as to whether the shoulder is a left shoulder or a right shoulder are necessary in subsequent processing. If such information can be obtained, the processing of joining the joints and estimating the posture can be omitted.

Further, according to the document 1, a case where a plurality of persons is captured in the image can also be coped with. In a case where a plurality of persons is captured, the following processing is also executed in joining the joints.

In the case where a plurality of persons is captured in an image, there is a possibility that a plurality of combinations of ways of joining the left shoulder and the left elbow exists, for example. For example, there is a possibility that the left shoulder of a person A is combined with the left elbow of the person A, the left elbow of a person B, the left elbow of a person C, or the like. To estimate a correct combination when there is a plurality of combinations, a technique called part affinity fields (PAFs) is used. According to this technique, a correct combination can be estimated by predicting a connectable possibility between joints as a direction vector map.

In the case where the number of captured persons is one, the estimation processing by the PAFs technique and the like can be omitted.

In step S104, the characteristic point detection unit 124 detects a portion representing the physical characteristic of the person from the image as the characteristic point. In the case of using the predetermined algorithm for this detection, accurate detection of the characteristic point is sufficient to the extent that the subsequent processing, specifically, processing described below by the position detection unit 125 can be performed. In other words, it is not necessary to execute all the above-described processing (the processing described in the document 1 as an example), and execution of only processing for detecting the characteristic point with high accuracy is sufficient to the extent that the processing described below by the position detection unit 125 can be executed.

In a case of detecting the characteristic point by analyzing the image using the predetermined algorithm, the physical characteristic such as the joint position of a person can be detected without troubling the user. Meanwhile, there is a possibility of occurrence of erroneous detection or detection omission.

The detection of the characteristic point by a person and the detection of the characteristic point using the predetermined algorithm may be combined. For example, after the characteristic point is detected by an image analysis using the predetermined algorithm, verification as to whether or not the characteristic point detected by a person is correct, correction in the case of erroneous detection, addition in the case of detection omission, and the like may be performed.

Furthermore, in the case of detecting the characteristic point using the predetermined algorithm, an image analysis used for face authentication is also used and different algorithms are applied to a face portion and a body portion, and the respective characteristic points may be detected from the face portion and the body portion.

In step S104 (FIG. 6), the characteristic point detection unit 124 detects the physical characteristic points of the person from the image. Here, the description will be continued using the case where the eighteen points of a left shoulder, a right shoulder, a left elbow, a right elbow, a left wrist, a right wrist, a neck, a left hip, a right hip, a left knee, a right knee, a left ankle, a right ankle, a right eye, a left eye, a nose, a mouth, a right ear, and a left ear of a person are detected as the characteristic points.

In step S105, the position detection unit 125 calculates parameters. The characteristic point detected by the characteristic point detection unit 124-1 from the image imaged by the imaging device 11-1 and the characteristic point detected by the characteristic point detection unit 124-2 from the image imaged by the imaging device 11-2 are supplied to the position detection unit 125, and the position detection unit 125 calculates the relative positions of the imaging device 11-1 and the imaging device 11-2 using the supplied characteristic points. As described above, in this case, the relative position is the position of the imaging device 11-2 with respect to the imaging device 11-1 when the imaging device 11-1 is set as the reference.

The position detection unit 125 calculates parameters called external parameters as the relative position of the imaging device 11. The external parameters of the imaging device 11 (generally referred to as external parameters of a camera) are rotation and translation (rotation vector and translation vector). The rotation vector represents the orientation of the imaging device 11, and the translation vector represents the position information of the imaging device 11. Furthermore, in the external parameters, the origin of the coordinate system of the imaging device 11 is at an optical center, and an image plane is defined by the X axis and the Y axis.

The external parameters are obtained and calibration of the imaging device 11 can be performed using the external parameters. Here, a method of obtaining the external parameters will be described. The external parameters can be obtained using an algorithm called 8-point algorithm.

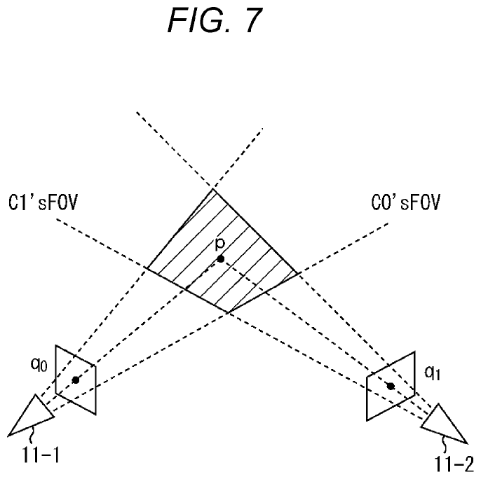

Assume that a three-dimensional point p exists in a three-dimensional space as illustrated in FIG. 7, and projected points on an image plane when the imaging device 11-1 and the imaging device 11-2 capture the point are q0 and q1, respectively. The following relational expression (1) is established between the projected points q0 and q1.

### [Expression 1]

In the expression (1), F is a fundamental matrix. This fundamental matrix F can be obtained by preparing eight or more pairs of coordinate values of when certain three-dimensional points are captured by imaging devices 11, such as (q0, q1), and applying the 8-point algorithm or the like.

Moreover, the expression (1) can be expanded to the following expression (2), using internal parameters (K0, K1) that are parameters unique to the imaging device 11, such as a focal length and an image center, and an essential matrix E. Furthermore, the expression (2) can be expanded to an expression (3).

### [Expression 2]

### [Expression 3]

In a case where the internal parameters (K0, K1) are known, an E matrix can be obtained from the above-described pairs of corresponding points. Moreover, this E matrix can be decomposed into the external parameters by singular value decomposition. Furthermore, the essential matrix E satisfies the following expression (4) where vectors representing the point p in the coordinate system of the imaging device are p0 and p1.

### [Expression 4]

At this time, the following expression (5) is established in a case where the imaging device 11 is a perspective projection imaging device.

### [Expression 5]

At this time, the E matrix can be obtained by applying the 8-point algorithm to the pair (p0, p1) or the pair (q0, q1). From the above, the fundamental matrix and the external parameters can be obtained from the pairs of corresponding points obtained between the images imaged by the plurality of imaging devices 11.

The position detection unit 125 calculates the external parameters by performing processing to which such an 8-point algorithm is applied. In the above description, the eight pairs of corresponding points used in the 8-point algorithm are pairs of the characteristic points detected as the positions of the physical characteristics of a person. Here, a pair of the characteristic points will be additionally described.

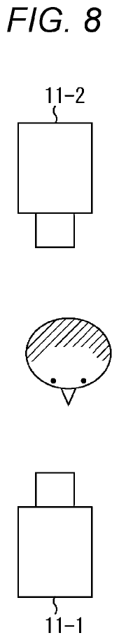

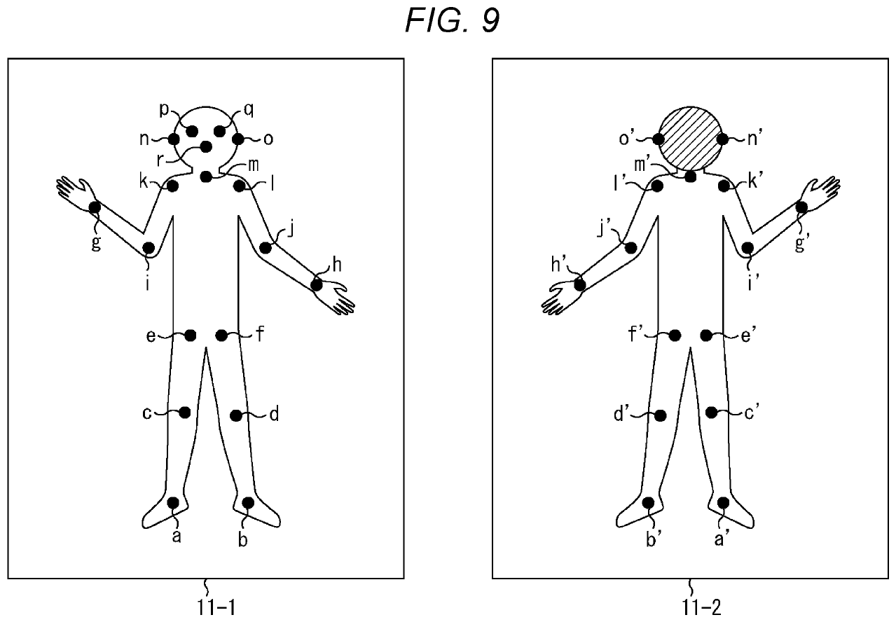

To describe a pair of the characteristic points, the characteristic points detected in a situation as illustrated in FIG. 8 will be described as an example. As illustrated in FIG. 8, the imaging device 11-1 and the imaging device 11-2 are arranged at positions of 180 degrees and are capturing a person. FIG. 8 illustrates a state in which the imaging device 11-1 is capturing the person from the front and the imaging device 11-2 is capturing the person from a back side. When the imaging devices 11 are arranged in this manner, the image imaged by the imaging device 11-1 (the characteristic points detected from the image) is illustrated in the left diagram in FIG. 9 and the image imaged by the imaging device 11-2 (the characteristic points detected from the image) is illustrated in the right diagram in FIG. 9.

Since the imaging device 11-1 images the subject (person) from the front, eighteen points are detected as the characteristic points as illustrated in the left diagram in FIG. 9. The characteristic point detection unit 124 provides information (described as characteristic point position) indicating which part of the person the detected characteristic point is detected from, and information (described as characteristic point identifier) for identifying the characteristic point. The characteristic point identifier may be information that can identify individual characteristic points, and for example, numbers, alphabets, or the like are assigned. In FIG. 9, description is given using a case where alphabets are provided as the characteristic point identifiers as an example. Furthermore, if a rule is provided such that a is assigned to an identifier associated with a characteristic point position, for example, a right ankle, as the characteristic point identifier, the characteristic point identifier a can be uniquely identified as the characteristic point detected from the right ankle portion Hereinafter, the description will be continued on the assumption that the description of the characteristic point a or the like indicates that the characteristic point identifier is a and the characteristic point a represents the characteristic point detected from a predetermined position, for example, the right ankle portion.

Referring to the left diagram in FIG. 9, characteristic points a to r are detected from an image 11-1 imaged by the imaging device 11-1. The characteristic point a is a characteristic point detected from the right ankle portion, and the characteristic point b is a characteristic point detected from the left ankle portion. The characteristic point c is a characteristic point detected from the right knee portion, and the characteristic point d is a characteristic point detected from the left knee portion.

The characteristic point e is a characteristic point detected from the right waist portion, and the characteristic point f is a characteristic point detected from the left waist portion. The characteristic point g is a characteristic point detected from the right wrist portion, and the characteristic point h is a characteristic point detected from the left wrist portion. The characteristic point i is a characteristic point detected from the right elbow portion, and the characteristic point j is a characteristic point detected from the left elbow portion.

The characteristic point k is a characteristic point detected from the right shoulder portion, and the characteristic point 1 is a characteristic point detected from the left shoulder portion. The characteristic point m is a characteristic point detected from the neck portion. The characteristic point n is a characteristic point detected from the right ear portion, and the characteristic point o is a characteristic point detected from the left ear portion. The characteristic point p is a characteristic point detected from the right eye portion, and the characteristic point q is a characteristic point detected from the left eye portion. The characteristic point r is a characteristic point detected from the nose portion.

Referring to the right diagram in FIG. 9, characteristic points a′ to o′ are detected from an image 11-2 imaged by the imaging device 11-2. The characteristic points (characteristic point identifiers) detected from the image 11-2 are described with a dash, and the same identifiers represent the same place, for example, the identifier a and the identifier a′ represent the characteristic points detected from the right ankle. Since the imaging device 11-2 captures the back of the person, the eyes and nose detected from the face portion are not detected, so a characteristic points p′, a characteristic point q′, and a characteristic point r′ are not illustrated.

The characteristic points described with reference to FIG. 9 are input to the position detection unit 125 (FIG. 5). Information indicating which imaging device 11 has imaged the characteristic points (described as imaging device specifying information) and information of a capture frame number and the like are also input to the position detection unit 125, as the information regarding the characteristic points, in addition to the information such as the characteristic point positions and the characteristic point identifiers.

The capture frame number is information for identifying an image to be processed and can be a number sequentially assigned to each frame after capture by the imaging device 11 is started, for example. The imaging device specifying information and the capture frame number are transmitted together with (included in) the image data from the imaging device 11. Other information such as capture time may also be transmitted together with the image data.

The position detection unit 125 associates the characteristic points extracted from the images respectively captured by the imaging device 11-1 and the imaging device 11-2, using the supplied information. What are associated are the characteristic points extracted from the same place, in other words, the characteristic points at the same characteristic point position. For example, in the case illustrated in FIG. 9, the characteristic point a and the characteristic point a′ detected from the right ankle are associated, and the characteristic point b and the characteristic point b′ detected from the left ankle are associated. Hereinafter, the associated two characteristic points are described as corresponding points.

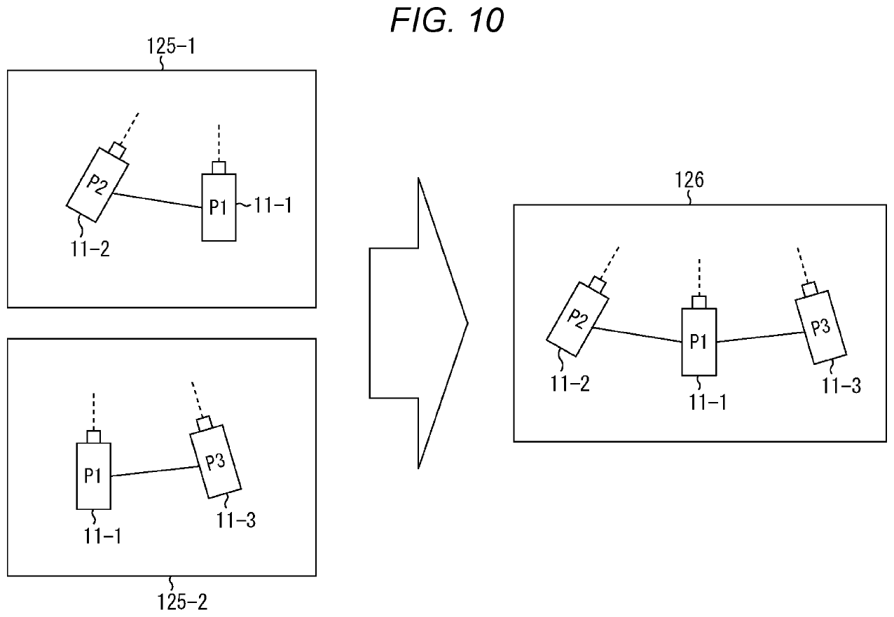

In a case of calculating the external parameters using the 8-point algorithm, eight pairs of corresponding points are sufficient. Since eighteen characteristic points are detected from the image 11-1 and the fifteen characteristic points are detected from the image 11-2, fifteen pairs of the corresponding points are obtained. Eight pairs of corresponding points out of the fifteen pairs of the corresponding points are used, and the external parameters are calculated as described above. The 8-point algorithm is used to obtain relative rotation of two imaging devices 11 and change in the position information. Therefore, to obtain the position information of two or more of a plurality of imaging devices, for example, to obtain the position information of the three imaging devices 11-1 to 11-3, as illustrated in FIG. 10, one imaging device 11 is set as the reference, and the relative positions with respect to the reference imaging device 11 are obtained.

since the information processing apparatus 12a illustrated in FIG. 5 has the configuration for obtaining the positional relationship between two imaging devices 11, one position detection unit 125 is required. To obtain the position information of N imaging devices 11, (N−1) position detection units 125 are provided in the information processing apparatus 12. For example, in a case of obtaining the position information of three imaging devices 11-1 to 11-3, two position detection unit 125-1 and position detection unit 125-2 are required. The left diagram in FIG. 10 illustrates the positional relationships detected by the position detection unit 125, and the right diagram in FIG. 10 illustrates the positional relationship integrated by the position integration unit 126. Referring to the left diagram in FIG. 10, the position information of the imaging device 11-2 with respect to the imaging device 11-1 is detected by the position detection unit 125-1. In a case where the position information of the imaging device 11-1 is a position P1, a position P2 of the imaging device 11-2 with respect to the position P1 is detected by the position detection unit 125-1. In the example illustrated in FIG. 10, the imaging device 11-2 being located on the left side of the imaging device 11-1 and at a slightly upper position than the imaging device 11-1 is detected. Furthermore, an optical axis of the imaging device 11-2 being located in a direction with an upper right inclination with respect to an optical axis of the imaging device 11-1 is also detected.

Similarly, position information of an imaging device 11-3 with respect to the imaging device 11-1 is detected by the position detection unit 125-2. In a case where the position of the imaging device 11-1 is the position P1, a position P3 of the imaging device 11-3 with respect to the position P1 is detected by the position detection unit 125-2. In the example illustrated in FIG. 10, the imaging device 11-3 being located on the right side of the imaging device 11-1 and at a slightly upper position than the imaging device 11-1 is detected. Furthermore, an optical axis of the imaging device 11-3 being located in a direction with an upper left inclination with respect to the optical axis of the imaging device 11-1 is also detected.

The position integration unit 126 acquires information (information of the position P2) regarding the relative position of the imaging device 11-2 of when the imaging device 11-1 is set as the reference from the position detection unit 125-1 and information (information of the position P3) regarding the relative position of the imaging device 11-3 of when the imaging device 11-1 is set as the reference from the position detection unit 125-2. The position integration unit 126 integrates the pieces of the position information of the imaging device 11-2 and the imaging device 11-3 with the imaging device 11-1 as the reference, thereby detecting the positional relationship illustrated in the right diagram in FIG. 10. In the position integration unit 126, information that the imaging device 11-2 is located at the position P2 and the imaging device 11-3 is located at the position P3 with the imaging device 11-1 as the reference, in other words, with the position P1 as the reference, is generated.

As described above, the information processing apparatus 12a sets the position of one imaging device 11 out of the plurality of imaging devices 11 as the reference, and detects and integrates the relative positional relationships between the reference imaging device 11 and the other imaging devices 11, thereby detecting the positional relationship among the plurality of imaging devices 11.

Since the case of two imaging devices 11 has been described here as an example, the information processing apparatus 12a has a configuration as illustrated in FIG. 5. Returning to the description of the operation of the information processing apparatus 12a illustrated in FIG. 5, in step S105 (FIG. 6), the relative position (external parameters) between the imaging device 11-1 and the imaging device 11-2 is obtained by the position detection unit 125.

Since the relative positions of the imaging device 11-1 and the imaging device 11-2 have been detected by the processing so far, the relative positions detected at this point of time are supplied to the position integration unit 126, and the processing may be moved onto processing of integrating the position information of the imaging device 11-1 and the imaging device 11-2.

Integration by the position integration unit 126 includes processing of integrating the relative position of another imaging device 11 when a predetermined imaging device 11 is set as a reference in a case where there are three or more of a plurality of imaging devices 11, as described with reference to FIG. 10. Furthermore, the integration by the position integration unit 126 includes processing of integrating the relative positions of the imaging device 11-1 and the imaging device 11-2 detected by the position detection unit 125, the position information of the imaging device 11-1 tracked by the position tracking unit 127-1, and the position information of the imaging device 11-2 tracked by the position tracking unit 127-2. This integration will be described below.

In step S105, processing of increasing the accuracy of the external parameters calculated by the position detection unit 125 may be further executed. In the above-described processing, the external parameters are obtained using the eight pairs of corresponding points. The accuracy of the external parameters to be calculated can be increased by calculating the external parameters from more information.

Processing of increasing the accuracy of the external parameters of the imaging device 11 using eight or more pairs of the corresponding points will be described. To increase the accuracy of the external parameters, verification as to whether or not the calculated external parameters are correct is performed.

To increase the accuracy of the external parameters to be calculated, an external parameter having the highest consistency with the positions of the remaining characteristic points is selected from external parameters obtained from arbitrarily or randomly selected eight pairs of corresponding points. The consistency in this case means that, when corresponding points other than the eight pairs of corresponding points used for the calculation of the external parameters are substituted into the above-described expression (1), the right side becomes 0 if the calculated external parameters of the imaging device 11 are correct or an error E occurs if the calculated external parameters are not correct.

For example, in a case where the external parameters are obtained from the eight pairs of the corresponding points of the characteristic points a to h and the characteristic points a′ to h′, and when the obtained external parameters and any one pair of the corresponding points of the characteristic points i to o and the characteristic points i′ to o′ are substituted to the expression (1), it can be determined that the correct external parameters have been calculated in a case where a result becomes 0 and it can be determined that wrong external parameters have been calculated in a case where the result becomes the error E other than 0.

In a case where the substitution result is the error E, the external parameters are obtained from the corresponding points other than the eight pairs of corresponding points of the characteristic points a to h and the characteristic points a′ to h′ used when the external parameters are previously calculated, for example, the characteristic points a to g and i and the characteristic points a′ to g′ and i′, and the obtained external parameters and the corresponding points other than the eight pairs of corresponding points of the characteristic points a to g and i and the characteristic points a′ to g′ and i′ are substituted into the expression (1), and whether or not the error E occurs is determined.

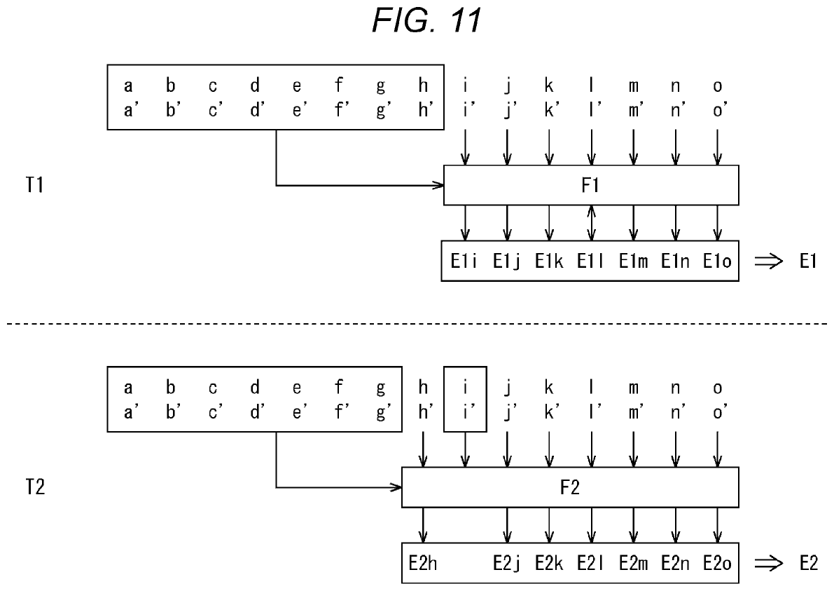

The external parameter with the substitution result of 0 or with the error E of the smallest value can be estimated as an external parameter calculated with the highest accuracy. The case of performing such processing will be described with reference to FIG. 11 again.

At a time T1, the external parameters are obtained from the eight pairs of corresponding points between the characteristic points a to h and the characteristic points a′ to h′, and the fundamental matrix F1 is calculated. The corresponding points between the characteristic point i and the characteristic point i′ are substituted into the expression (1) where the fundamental matrix F1 is F in the expression (1). The calculation result at this time is an error Eli. Likewise, the corresponding points between the characteristic point j and the characteristic point j′ are substituted into the expression (1), where the fundamental matrix F1 is F in the expression (1), and an error E1j is calculated.

Errors E1k to E1o are calculated by executing the calculation where the fundamental matrix F1 is F in the expression (1), for the respective corresponding points between the characteristic points k to o and the characteristic points k′ to o′. A value obtained by adding all the calculated errors E1i to E1o is set as an error E1.

At a time T2, the external parameters are obtained from the eight pairs of corresponding points between the characteristic points a to g and i and the characteristic points a′ to g′ and i′, and a fundamental matrix F2 is calculated. The corresponding points between the characteristic point h and the characteristic point h′ are substituted into the expression (1), where the fundamental matrix F2 is F in the expression (1), and an error E2h is calculated. Likewise, errors E2j to E2o are calculated by executing the calculation where the fundamental matrix F2 is F in the expression (1), for the respective corresponding points between the characteristic points j to o and the characteristic points j′ to o′. A value obtained by adding all the calculated error E2h and errors E2j to E1o is set as an error E2.

As described above, the external parameters are calculated using the eight pairs of corresponding points and the errors E of the calculated external parameters are respectively calculated using the corresponding points other than the eight pairs of corresponding points used for the calculation, and the total value is finally calculated. Such processing is repeatedly performed while changing the eight pairs of corresponding points used for calculating the external parameters.

In a case of selecting eight pairs of corresponding points from fifteen pairs of corresponding points and calculating the external parameters, 15C8 external parameters are calculated and the error E is calculated from a combination formula when calculating the external parameters for all the corresponding points. The external parameter of when the error E with the smallest value out of the 15C8 errors E is calculated is the external parameter calculated with the highest accuracy. Then, the subsequent processing is performed using the external parameter calculated with the highest accuracy, the position information of the imaging device 11 can be calculated with high accuracy.

Here, the external parameters are calculated using the eight pairs of corresponding points and the errors E of the calculated external parameters are calculated using the corresponding points other than the eight pairs of corresponding points used for the calculation, and added values are compared. As another method, maximum values of the errors E obtained when the corresponding points before addition are substituted may be compared in the above description without addition.

When the maximum values of the errors E are compared, an error E with the smallest maximum value is extracted, and the external parameter of when the extracted error E is calculated may be calculated as the external parameter calculated with the highest accuracy. For example, in the above-described example, the maximum value in the errors E1i to E1o and the maximum value in the error E2h and the errors E2j to E1o are compared, and the external parameter of when a smaller error E is calculated may be set as the external parameter calculated with the highest accuracy.

Further, the external parameter calculated with the highest accuracy may be calculated using a median value of the errors E or an average value of the errors E, instead of the maximum value of the errors E.

Further, in the case of using the maximum value, the median value, or the average value of the errors E, processing of excluding the characteristic point with a large error may be performed in advance by threshold processing in order to exclude an outlier. For example, at the time T1 in FIG. 11, the errors E1i to E1o are calculated. In a case where the error E1o in the errors E1i to E1o is equal to or larger than a threshold value, for example, the maximum value, the median value, or the average value may be calculated using the errors E1i to E1n excluding the error E1o.

Furthermore, according to the processing (processing of calculating the characteristic points) based on the above-described document 1, reliability of each characteristic point can be calculated as additional information. The external parameters may be calculated taking the reliability into account. In a case of imaging a person and detecting a characteristic point, the reliability of the detected characteristic point differs depending on the posture of the person, or the position or the angle of the imaging device with respect to the person.

For example, as illustrated in FIG. 9, the reliability of a characteristic point n at a right eye position of when the person is imaged from the front is high but the reliability of a characteristic point n′ at the right eye position of when the person is imaged from the back is low even if detected.

For example, the external parameters may be obtained using top eight pairs of corresponding points of the characteristic points having high reliability.

Furthermore, in the case of executing the above-described processing of improving the accuracy of the external parameters, the processing may be executed using only the characteristic points having the reliability of a predetermined threshold value or more. In other words, the external parameters are obtained using the eight pairs of corresponding points having the reliability of the predetermined threshold value or more, and the errors E may be calculated using the corresponding points of the characteristic points other than the eight pairs of corresponding points used for calculating the external parameters and having the reliability of the predetermined threshold value or more.

Furthermore, the reliability may be used as weighting. For example, in a case of calculating total values of the errors E and comparing the total values in the processing of improving the accuracy of the external parameters, the total values may be calculated such that weighting of an error E calculated from the characteristic point with high reliability is made large and weighting of an error E calculated from the characteristic point with low reliability is made small. In other words, the total value of the errors E may be calculated treating the error E calculated in the calculation using the characteristic point with high reliability as the error E with high reliability, and the error E calculated in the calculation using the characteristic point with low reliability as the error E with low reliability.

The reliability of the external parameters, that is, the accuracy of the external parameters can be improved by the calculation using the reliability.

In step S105 (FIG. 6), the position information (external parameters) calculated by the position detection unit 125 (FIG. 5) is supplied to the position integration unit 126.

In step S106, the position integration unit 126 integrates the position information.

In parallel with such processing, processing in the position tracking unit 127 is also executed. The image input to the image input unit 121 is also supplied to the position tracking unit 127, and the processing by the position tracking unit 127 is performed in parallel with the processing in steps S102 to S105 executed by the person detection unit 122 to the position detection unit 125.

Processing in steps S107 to S112 is basically the processing executed by the position tracking unit 127. Since the processing executed by the position tracking unit 127-1 and the position tracking unit 127-2 is the same as processing except that the treated image data is different, the description will be continued as the processing by the position tracking unit 127.

In step S107, the position tracking unit 127 determines whether or not all the imaging devices 11 are stationary. Since the case where the number of imaging devices 11 is two is described as an example here, whether or not the two imaging devices 11 are in a stationary state is determined.

In step S107, since whether or not both the two imaging devices are in a stationary state is determined, in a case where both the two imaging devices are moving or one of the two imaging devices is moving, NO is determined in step S107. In step S107, in a case where it is determined that the two imaging devices 11 are in a stationary state, the processing proceeds to step S108. In step S108, tracking of the position information in the position tracking unit 127 is initialized. In this case, in a case where one or two of the two imaging devices 11 are in a moving state, tracking (position information detection) of the position information of the imaging device 11 executed in the position tracking unit 127 is initialized.

The position tracking unit 127 estimates a moving amount of the imaging device 11 by applying the self-position estimation technology called SLAM or the like and estimates the position. SLAM is a technology that performs self-position estimation and map creation at the same time from information acquired from various sensors, and is a technology used for autonomous mobile robots or the like. The position tracking unit 127 only needs to be able to perform self-position estimation, and may not perform map creation in a case of applying SLAM and performing the self-position estimation.

An example of processing related to the self-position estimation by the position tracking unit 127 will be described. The position tracking unit 127 extracts a characteristic point from an image imaged by the imaging device 11, searches for a characteristic point extracted from an image of a previous frame and coinciding with the extracted characteristic point, and generates a corresponding pair of the characteristic points. What is extracted as a characteristic point is favorably a characteristic point from a subject that is an unmoving object, such as a building, a tree, or a white line of a road, for example.

In this case as well, the description will be continued on the assumption that the characteristic point is extracted, but the characteristic point may be a region instead of a point. For example, an edge portion is extracted from an image, a region having the edge is extracted as a region having a characteristic, and the region may be used in subsequent processing.

Further, here, the description will be continued using the case in which the characteristic point extracted from the image of one previous frame is compared with the characteristic point extracted from the image of the current frame as an example. However, the present technology can also be applied to a case where several previous frame, not the one previous frame, is compared with the current frame. Furthermore, timing when the frame (image) is acquired may be general timing, for example, timing such as thirty frames in one second or may be another timing.

When the characteristic points are detected, the self-position, in this case, the position of the imaging device 11 is estimated using the corresponding pair of the characteristic points. This estimation result is position information, posture, or the like of the imaging device 11. At which position in the current frame the characteristic point of one previous frame is captured is estimated using the corresponding pair of the characteristic points, so that a moving direction is estimated.

The position tracking unit 127 performs such processing every time a frame (image) is supplied, thereby continuing estimation of the position information of the imaging device 11. In the case of calculating the moving amount of the imaging device 11 from a relative moving amount of the characteristic point in the image in this way, the relative position of the imaging device 11 is integrated in the time direction, and if an error occurs, there is a possibility that the error is also accumulated. To prevent error accumulation, initialization is performed at predetermined timing. Furthermore, in the case where the initialization is performed, the position information of the tracked imaging device 11 is lost, so the initial position information of the imaging device 11 is supplied from the position detection unit 125.

At the initialization timing, in step S107 (FIG. 6), whether or not all the imaging devices 11 are stationary is determined, and in a case where all the imaging devices 11 are determined to be stationary, the processing proceeds to step S108, and initialization of tracking is performed.

In a case where there is a plurality of imaging devices 11 and the plurality of imaging devices 11 is in the stationary state, the position detection executed in steps S102 to S105, in other words, the position information detected by the position detection unit 125 is preferentially used. It can be considered that the detection accuracy of the position information in the position detection unit 125 is high when the imaging device 11 is in the stationary state. In such a case, the position information detected by the position detection unit 125 is preferentially used.

In step S107, whether or not the imaging device 11 is stationary is determined. In other words, whether or not the imaging device 11 is moving is determined. The imaging device 11 being moving is that the imaging device 11 is physically moving. Furthermore, when a zoom function is being executed in the imaging device 11 is included in the case where the imaging device 11 is moving.

When the zoom function is being executed, there is a possibility that the accuracy of the position estimation of the imaging device 11 in the position tracking unit 127 decreases. For example, consider a case where the imaging device 11 is imaging a predetermined building A. In a case where the imaging device 11 moves toward the building A in an approaching direction, a ratio occupied by the building A in the image imaged by the imaging device 11 becomes large. In other words, the building A is imaged in a large size as the imaging device 11 approaches the building A.

Meanwhile, in a case where the zoom function is executed when the imaging device 11 is imaging the building A in a stationary state, the ratio occupied by the building A in the image imaged by the imaging device 11 similarly becomes large. In other words, the building A is imaged in a large size as the imaging device 11 executes the zoom function, as in the case where the imaging device 11 approaches the building A. In a case where the region of the imaged building A is enlarged in the image, determining whether the enlargement is by the movement of the imaging device 11 or by the zoom function from only the image is difficult.

As a result, the tracking result by the position tracking unit 127 during zooming of the imaging device 11 becomes low in reliability. To cope with such a situation, use of the result of the self-position estimation by the position tracking unit 127 is avoided when zooming is executed in the position integration unit 126.

When it is determined in step S107 that the imaging device 11 is moving is when the imaging device 11 is physically moving and when the zoom function is being executed. According to the present technology, even when the accuracy of the self-position estimation by the position tracking unit 127 is lowered because the imaging device 11 is executing the zoom function, the position information detected by the position detection unit 125 is used without using the self-position estimation, whereby the position of the imaging device 11 can be specified.

As described above, the position detection unit 125 detects the physical characteristic point of a person and detects the position information of the imaging device 11 using the characteristic point. Even if the imaging device 11 is zooming, the position detection unit 125 can detect the position information if change in the angle of view due to zooming is known. Generally, since the zooming of the imaging device 11 asynchronously operates with the imaging timing of the imaging device 11, accurately determining the angle of view during zooming is difficult.

However, an approximate value can be estimated from a zoom speed. There is a possibility that the detection accuracy of the position of the imaging device 11 is lowered during zooming, but the detection of the position information by the position detection unit 125 can be continuously performed even during zooming. Furthermore, even when the detection accuracy of the position information is lowered during zooming, the detection accuracy of the position information can be restored after termination of the zooming.

According to the present technology, there are the position information detected by the position detection unit 125 and the position information detected by the position tracking unit 127. The position information detected by the position detection unit 125 is used and use of the position information detected by the position tracking unit 127 can be avoided when the imaging device 11 is executing the zoom function.

Furthermore, both the position information detected by the position detection unit 125 and the position information detected by the position tracking unit 127 can be used when the imaging device 11 is not executing the zoom function.

Furthermore, the position information detected by the position detection unit 125 is preferentially used to the position information detected by the position tracking unit 127 when the imaging device 11 is stationary, and at that time, the position tracking by the position tracking unit 127 can be initialized to eliminate the error.

Returning to the description with reference to the flowchart in FIG. 6 and the description will be continued about the case where such processing is performed. In step S107, whether or not all the imaging devices 11 are stationary is determined. In a case where it is determined that at least one of the plurality of imaging devices 11 is moving, the processing proceeds to step S109.

Whether or not the imaging device 11 is physically moving can be determined by the position tracking unit 127.

Although arrows are not illustrated in FIG. 5, the position tracking units 127 are configured to exchange determination results as to whether or not the imaging device 11 is moving.

In step S109, the position tracking unit 127 continuously tracks the position information. In other words, in this case, the position tracking by the position tracking unit 127 is continuously performed when the imaging device 11 is moving.

In step S110, whether or not all the imaging devices 11 are stationary is determined. The determination in step S110 is the same as the determination in step S107. The processing proceeds to step S110 in a case where it is determined in step S107 that there is a moving imaging device 11 in the imaging devices 11 or when it is determined in step S103 that there is not the same person. In a case where it is determined in step S107 that there is a moving imaging device 11 and the processing proceeds to step S110, it is also determined in step S110 that there is a moving imaging device 11 and the processing proceeds to step S111. In step S111, the position information of the tracking result in the position tracking unit 127 is output to the position integration unit 126.

Meanwhile, in a case where it is determined in step S103 that there is not the same person and the processing proceeds to step S110, this case is in a state where detection of the position information is not performed by the position detection unit 125. In such a case, in a case where it is determined in step S110 that there is a moving imaging device 11, the processing proceeds to step S111, and the position information of the tracking result of the position tracking unit 127 is output to the position integration unit 126.

On the other hand, in a case where it is determined in step S110 that all the plurality of imaging devices 11 are stationary, the processing proceeds to step S112. In step S112, the same position information as the previous time is output from the position tracking unit 127 to the position integration unit 126.

This case is in the state where detection of the position information is not performed by the position detection unit 125 and the state in which the position information by the position tracking unit 127 has been initialized. Since the imaging device 11 is not moving, there is no change in the position information of the imaging device 11, the position information that has been previously detected by the position tracking unit 127, in other words, the position information just before the initialization is performed is output to the position integration unit 126.

Here, in the step S112, the description will be continued on the assumption that a previous output result is output. However, the position information may not be output. As described above, since there is no change in the position information of the imaging device 11, the position integration unit 126 can use the same information as the previous time without outputting. In other words, the position integration unit 126 holds the position information, and when the position information from the position detection unit 125 or the position tracking unit 127 is not input, the position integration unit 126 can use the held position information.

In step S106, the position integration unit 126 integrates the pieces of the position information respectively output from the position detection unit 125 and the position tracking unit 127 to specify the position of the imaging device 11.

As described with reference to FIG. 10, this integration includes a processing of setting a reference imaging device 11 in a case where three or more imaging devices 11 are imaging devices to be processed, specifying the position information of the other imaging devices 11 with respect to the reference imaging device 11, thereby integrating pieces of the position information of the plurality of imaging devices 11. This integration is the case of a plurality of position detection units 125 and a case of integrating pieces of the position information from the plurality of position detection units 125. Furthermore, in the case of the configuration provided with the position detection unit 125, the position tracking unit 127-1, and the position tracking unit 127-2, as in the configuration of the information processing apparatus 12a illustrated in FIG. 5, there is also processing of integrating pieces of the position information output from the aforementioned units.

The processing proceeds to step S106 in the case where parameters are calculated by the position detection unit 125 in step S105 and the position information is output by the position tracking unit 127 in step S111 (case 1). Furthermore, the processing proceeds to step S106 in the case where the parameters are calculated by the position detection unit 125 in step S105 and the same information as the previous time is output by the position tracking unit 127 in step S112 (the case of initialization in step S108) (case 2).

Furthermore, the processing proceeds to step S106 in the case where the same person is not detected in step S103 and the position information is output by the position tracking unit 127 in step S111 (case 3).

Furthermore, the processing proceeds to step S106 in the case where the same person is not detected in step S103 and the same information as the previous time is output by the position tracking unit 127 in step S112 (the case of initialization in step S108) (case 4).

The position integration unit 126 selects and integrates the position information according to the cases 1 to 4. As a basic operation, when the relative positions (external parameters) of the imaging device 11-1 and the imaging device 11-2 are calculated by the position detection unit 125 by the execution of the processing up to step S105, as in the cases 1 and 2, the position information detected by the position detection unit 125 is selected and output by the position integration unit 126. In other words, when the position information is detected by the position detection unit 125, the position information detected by the position detection unit 125 is preferentially output to other detected position information.

More specifically, the case 1 is a situation in which the position information of the imaging device 11-1 is supplied from the position tracking unit 127-1, the position information of the imaging device 11-2 is supplied from the position tracking unit 127-2, and the position information regarding the relative positions of the imaging device 11-1 and the imaging device 11-2 is supplied from the position detection unit 125 to the position integration unit 126.

In such a situation, the position integration unit 126 executes processing such as weighting to be described below and integrates and outputs the position information from the position tracking unit 127-1, the position information from the position tracking unit 127-2, and the position information from the position detection unit 125.

The case 2 is a situation in which the previous position information of the imaging device 11-1 is supplied from the position tracking unit 127-1, the previous position information of the imaging device 11-2 is supplied from the position tracking unit 127-2, and the position information regarding the relative positions of the imaging device 11-1 and the imaging device 11-2 is supplied from the position detection unit 125 to the position integration unit 126.

In such a situation, the position integration unit 126 executes processing such as weighting to be described below and integrates and outputs the position information from the position tracking unit 127-1, the position information from the position tracking unit 127-2, and the position information from the position detection unit 125.

In the case 2, since the position information from the position tracking unit 127-1 and the position information from the position tracking unit 127-2 are the previous position information, only the position information from the position detection unit 125 may be selected and output without integration.

Processing of not outputting the position information may be configured in step S112. The case of such a configuration is in a state where only the position information from the position detection unit 125 is supplied to the position integration unit 126. Therefore, the position information from the position detection unit 125 is output.

The case 3 is a situation in which the position information of the imaging device 11-1 is supplied from the position tracking unit 127-1, the position information of the imaging device 11-2 is supplied from the position tracking unit 127-2, and the position information from the position detection unit 125 is not supplied to the position integration unit 126.

In such a situation, the position integration unit 126 integrates and outputs the position information from the position tracking unit 127-1 and the position information from the position tracking unit 127-2.

The case 4 is a situation in which the previous position information of the imaging device 11-1 is supplied from the position tracking unit 127-1, the previous position information of the imaging device 11-2 is supplied from the position tracking unit 127-2, and the position information from the position detection unit 125 is not supplied to the position integration unit 126.

In such a situation, the position integration unit 126 integrates and outputs the position information from the position tracking unit 127-1 and the position information from the position tracking unit 127-2.

Alternatively, in the case 4, since the position information from the position tracking unit 127-1 and the position information from the position tracking unit 127-2 are the previous position information, the same position information as the previous output result may be output without integration.

Furthermore, processing of not outputting the position information may be configured in step S112. The case of such a configuration is in a situation where the position information is not supplied to the position integration unit 126 from any of the position tracking unit 127-1, the position tracking unit 127-2, and the position detection unit 125. In such a situation, the previous position information held in the position integration unit 126 is output.

In any of the cases 1 to 4, when it is determined that the zoom function is being executed by the imaging device 11, the position information from the position tracking unit 127 is controlled not to be used. In other words, in a case where the position integration unit 126 determines that zooming is being executed, even if the position information from the position tracking unit 127 is supplied, the integration processing is executed without using the supplied position information.

As described above, according to the present technology, the position information is detected by the position detection unit 125 and the position tracking unit 127 in different schemes, and the position information considered to have high accuracy is selected and output according to the situation.

In other words, the position detection unit 125 images a person, detects the physical characteristic points of the person, and detects the positional relationship of the imaging device 11, using the detected characteristic points. Therefore, when a person is not imaged, it is difficult for the position detection unit 125 to normally detect the position information. Even in such a case, since the position information can be detected by the position tracking unit 127 that performs the self-position estimation, the detection result by the position tracking unit 127 can be used.

Furthermore, the position tracking unit 127 may not be able to normally detect the position information when there is a possibility that errors are accumulated over time or the zoom function is executed. Even in such a case, since the position information by the position detection unit 125 can be performed, the detection result by the position detection unit 125 can be used.

To improve the accuracy of the position detected by the position detection unit 125 in the above-described processing, processing of smoothing the position information in the time direction may be included. To describe the smoothing, refer to FIG. 10 again. As illustrated in FIG. 10, a person is captured by the three imaging devices 11-1 to 11-3, the characteristic points serving as the physical characteristics of the person are detected from the captured images, and the position information of the imaging devices 11-1 to 11-3 is specified using the characteristic points. Here, if the same person is captured by the three imaging devices 11-1 to 11-3 at the same time, the respective pieces of the position information of the imaging devices 11-1 to 11-3 can be specified by the processing of the position detection unit 125.

However, there is a possibility that the same person is not captured by the imaging devices 11-1 to 11-3 at the same time. For example, there is a possibility of occurrence of a situation where, at the time t, the imaging device 11-1 and the imaging device 11-2 capture the person A but the imaging device 11-3 does not capture the person A. In such a situation, the characteristic point is not detected from the image captured by the imaging device 11-3, and the corresponding points to the characteristic points detected from the image captured by the imaging device 11-1 are not obtained.

When such a situation occurs, the position information is calculated using the characteristic points detected at a time other than the time t. Since a person moves, there is a high possibility that the imaging device 11-3 captures a person at another time even when the imaging device 11-3 has not captured a person at a predetermined time t.

Therefore, in a case where the characteristic points are not obtained from the image from the imaging device 11-3 at the time t, the position information of the imaging device 11-3 is calculated using the characteristic points detected from the image obtained when captured at preceding point of time or the characteristic points detected from the image obtained when becoming capturable at later point of time.

A position smoothing unit is provided at a subsequent stage of the position detection unit 125 and before the position integration unit 126. In addition, the position smoothing unit uses the position information when the position detection unit 125 can acquire the position information at the latest time t, and the position smoothing unit accumulates the result of the preceding time t−1 and uses the accumulated result when the position detection unit 125 does not acquire the position information.

By performing such processing by the position smoothing unit, the relative position of the imaging device 11 can be calculated even if not all the plurality of imaging devices 11 are installed in a state where the fields of view overlap, in other words, even if not all the plurality of imaging devices 11 are installed at positions where the imaging devices 11 can capture the same person at the same time.

In other words, the respective pieces of the position information of the plurality of imaging devices 11 can be calculated by the movement of the person even if the imaging devices 11 that are not the references are arranged in a state where the fields of view do not overlap as long as the fields of view overlap with the field of view of the reference imaging device 11.

The processing of smoothing the position information in the time direction may be performed in this way. By smoothing the position information in the time direction, the accuracy of the position detection can be further improved.

In the above processing, in the case where the position information of the imaging device 11-1 is supplied from the position tracking unit 127-1, the position information of the imaging device 11-2 is supplied from the position tracking unit 127-2, and the position information is supplied from the position detection unit 125 to the position integration unit 126, these pieces of the position information are integrated with weighting, and final position information (specified position) after integration may be able to be output.

In weighting, a coefficient used for weighting may be a fixed value or a variable value. The case of a variable value will be described.

The position detection by the position detection unit 125 is performed by detecting the physical characteristic points of a person by the characteristic point detection unit 124 and using the detected characteristic points. Further, the detection of the position information by the position tracking unit 127 is performed by detecting the characteristic points from a portion having a characteristic such as a building or a tree, and estimating the moving direction of the characteristic points. As described above, both the position detection unit 125 and the position tracking unit 127 perform processing using the characteristic points.

The position detection unit 125 and the position tracking unit 127 can detect the position information with higher accuracy as the number of characteristic points is larger. Therefore, the weight coefficient can be a coefficient according to the number of characteristic points.

The method of detecting the position information of the imaging device 11 using the physical characteristic points of a person has a possibility that the number of the characteristic points becomes small in a case where the number of imaged persons is not large or a case where a whole person is not captured, for example, and has a possibility that the detection accuracy of the position information becomes low.

Furthermore, the self-position tracking of the imaging device 11 can be more stably detected with more characteristic points in the image. Therefore, in the case where the output of the position detection unit 125 and the output of the position tracking unit 127 are input to the position integration unit 126, the outputs of both the units are integrated, and when the integration is performed, weighting is performed using a coefficient set according to the number of the characteristic points.

Specifically, reliability is calculated, and a weight coefficient according to the reliability is set. For example, although the position detection unit 125 has a large amount of physical characteristics of a person and is more accurate but all the physical characteristic points to be obtained are not necessarily detected depending on the posture of the person and how the person is captured. Therefore, reliability Rj is determined by the following expression (6), where the number of all the physical characteristic points is Jmax and the number of detected physical characteristic points is Jdet.

Rj=J det/J max (6)

Reliability Rs of the position tracking unit 127 is obtained as follows. The reliability Rs is obtained by the following expression (7), where all the characteristic points obtained in an image imaged by the imaging device 11 is Tmax and the number of correct characteristic points used for estimating the position information of the imaging device 11 out of Tmax is Tdet.

Rs=T det/T max (7)

The reliability Rj and the reliability Rs are numerical values from 0 to 1, respectively. A weight coefficient α is defined as the following expression (8) using the reliability Rj and Rs.

α=Rj/(Rj+Rs) (8)

The output from the position detection unit 125 is output Pj, and the output from the position tracking unit 127 is output Ps. The output Pj and the output Ps are vectors having three values representing x, y, z position information, respectively. An output value Pout is calculated by the following expression (9) using the weight coefficient α.

P out=α×Pj+(1−α)×Ps (9)

The output value Pout integrated in this way is output as an output from the position integration unit 126 to a subsequent processing unit (not illustrated).

When the imaging device 11 is stationary, the position information is smoothed in the time direction in detecting the position information of the imaging device 11 using the physical characteristic amount of a person, whereby the detection accuracy of the position information can be improved. Furthermore, when the imaging device 11 starts to move, the position tracking unit 127 can start tracking using the position information of the imaging device 11 just before movement as an initial value.

Further, the position tracking unit 127 may have errors accumulated over time, but the increase in error can be suppressed taking the information of the position detection unit 125 into account. Furthermore, since the detection accuracy of the position information by the position tracking unit 127 is lowered at the time of zooming, use of the detected position information can be avoided. In the meantime, the information of the position detection unit 125 is obtained. Therefore, the position information can be prevented from being interrupted and the detection of the position information with accuracy can be continuously performed.

### Second Embodiment

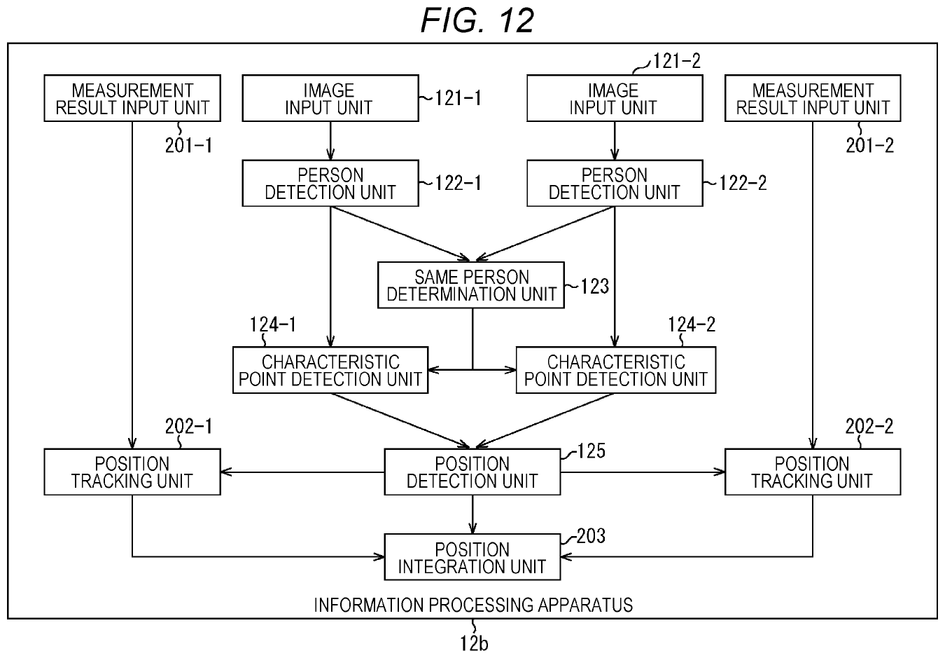

Next, an information processing apparatus 12b according to a second embodiment will be described. FIG. 12 is a diagram illustrating a configuration of the information processing apparatus 12b according to the second embodiment. The information processing apparatus 12b illustrated in FIG. 12 has a configuration of a case of processing images from two imaging devices 11-1 and 11-2, as in the information processing apparatus 12a according to the first embodiment illustrated in FIG. 5. The same parts as those of the information processing apparatus 12a according to the first embodiment illustrated in FIG. 6 are denoted by the same reference signs, and description of the same parts will be omitted as appropriate.

In the first embodiment, the case of applying the technology of performing an image analysis called SLAM or the like to estimate the self-position has been described as an example. The second embodiment is different from the first embodiment in estimating a self-position using a measurement result from an inertial measurement unit (IMU).

Referring to FIG. 12, a portion of specifying position information of the imaging devices 11 using physical characteristic points of a person in the information processing apparatus 12b has a configuration similar to the configuration of the information processing apparatus 12a according to the first embodiment. In other words, the information processing apparatus 12b includes an image input unit 121, a person detection unit 122, a same person determination unit 123, a characteristic point detection unit 124, and a position detection unit 125. The information processing apparatus 12b includes a measurement result input unit 201 that inputs a result measured by the inertial measurement unit from the imaging device 11 side and a position tracking unit 202 that detects the position information of the imaging device 11 using the measurement result input to the measurement result input unit 201.

A position integration unit 203 receives supply of the position information from the position detection unit 125, a position tracking unit 202-1 and a position tracking unit 202-2, generates final position information (specifies positions) using the position information, and outputs the final position information to a subsequent processing unit (not illustrated).

The inertial measurement unit is a device that obtains a three-dimensional angular velocity and acceleration with a triaxial gyro and a three-directional accelerometer. Furthermore, sensors such as a pressure gauge, a flow meter, a global positioning system (GPS) may be mounted. Such an inertial measurement unit is attached to the imaging device 11, and the information processing apparatus 12b acquires the measurement result from the inertial measurement unit. By attaching the inertial measurement unit to the imaging device 11, movement information such as how much and in which direction the imaging device 11 has moved can be obtained.

The information processing apparatus 12b can obtain information of the respective accelerations and inclinations in X, Y, and Z axial directions of the imaging device 11 measured by the inertial measurement unit. The position tracking unit 202 can calculate the speed of the imaging device 11 from the acceleration of the imaging device 11 and calculate a movement distance of the imaging device 11 from the calculated speed and elapsed time. By using such a technology, change in the position of the imaging device 11 at the time of movement can be captured.

In the case of obtaining the moving direction and the distance of the imaging device 11 using the result measured by the inertial measurement unit as described above, a relative movement amount is obtained and therefore initial position information needs to be provided. The initial position information can be the position information detected by the position detection unit 125.

In the case of obtaining the position information of the imaging device 11 using the measurement result of the inertial measurement unit, the moving amount of the imaging device 11 can be obtained regardless of whether or not the zoom function of the imaging device 11 is being executed, unlike the case of the first embodiment. Therefore, in the second embodiment, the outputs of both the position detection unit 125 and the position tracking unit 202 are used when the imaging device 11 is moving, and the output from the position detection unit 125 is preferentially used when the imaging device 11 is not moving.

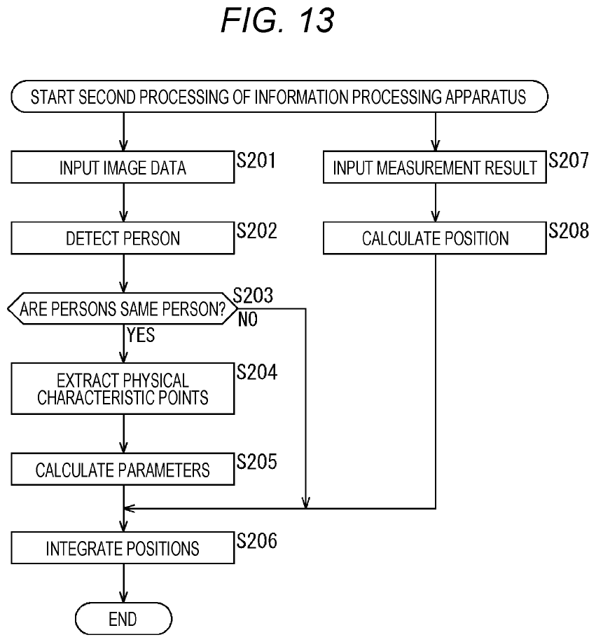

An operation of the information processing apparatus 12b illustrated in FIG. 12 will be described with reference to the flowchart in FIG. 13.

Processing in steps S201 to S206 is processing for detecting the position information of the imaging device 11 by the position detection unit 125, and is the same as the processing of the first embodiment. The processing in steps S201 to S206 is similar to the processing in steps S101 to S106 (FIG. 6), and description of the processing is omitted here as already described.

In step S207, the measurement result input unit 201 inputs the measurement result from the inertial measurement unit attached to the imaging device 11. The measurement result input unit 201-1 inputs the measurement result from the inertial measurement unit attached to the imaging device 11-1, and the measurement result input unit 201-2 inputs the measurement result from the inertial measurement unit attached to the imaging device 11-2.

In step S208, the position tracking unit 202 detects the position information of the imaging device 11 using the measurement results. The position tracking unit 202-1 analyzes an image imaged by the imaging device 11-1 to detect the position information of the imaging device 11-1. Furthermore, the position tracking unit 202-2 analyzes an image imaged by the imaging device 11-2 to detect the position information of the imaging device 11-2. The pieces of position information respectively detected by the position tracking unit 202-1 and the position tracking unit 202-2 are supplied to the position integration unit 203.

In step S206, the position integration unit 203 integrates the position information. Processing of the position integration unit 203 in step S206 will be described.

The processing proceeds to step S206 in the case where parameters are calculated by the position detection unit 125 in step S208 and the position information is output by the position tracking unit 202 in step S208 (case 1). Furthermore, the processing proceeds to step S206 in the case where the same person is not detected in step S203 and the position information is output by the position tracking unit 202 in step S208 (case 2).

The position integration unit 126 selects and integrates the position information according to the case 1 or case 2. In the case 1, the position information of the imaging device 11-1 is supplied from the position tracking unit 202-1, the position information of the imaging device 11-2 is supplied from the position tracking unit 202-2, and the position information of relative positions of the imaging device 11-1 and the imaging device 11-2 is supplied from the position detection unit 125 to the position integration unit 126. In such a situation, the position integration unit 126 integrates and outputs the position information from the position tracking unit 202-1, the position information from the position tracking unit 202-2, and the position information of the imaging device 11-1 and the imaging device 11-2 from the position detection unit 125.

As described in the first embodiment, this integration is performed by performing weighted calculations. The reliability of the position information from the position tracking unit 202 is calculated as 1. The reliability of the position information from the position tracking unit 202 corresponds to the above-described reliability Rs, and the calculation based on the expressions (8) and (9) is performed with the reliability Rs=1.

In the case 2, the position information of the imaging device 11-1 is supplied from the position tracking unit 202-1, the position information of the imaging device 11-2 is supplied from the position tracking unit 202-2, and the position information from the position detection unit 125 is not supplied to the position integration unit 126. In such a situation, the position integration unit 126 integrates and outputs the position information from the position tracking unit 202-1 and the position information from the position tracking unit 202-2.

As described above, according to the present technology, the position information is detected by the position detection unit 125 and the position tracking unit 202 in different schemes, and the position information considered to have high accuracy is selected and output according to the situation.

In other words, the position detection unit 125 images a person, detects the physical characteristic points of the person, and detects the positional relationship of the imaging device 11, using the detected characteristic points. Therefore, when a person is not imaged, it is difficult for the position detection unit 125 to normally detect the position information. Even in such a case, since the position information can be detected by the position tracking unit 202 that performs the self-position estimation, the detection result by the position tracking unit 202 can be used.

### Third Embodiment

Next, an information processing apparatus 12c according to a third embodiment will be described.

According to the information processing apparatus 12a in the first embodiment or the information processing apparatus 12b in the second embodiment, even if the imaging device 11 is moving, the relative position of the imaging device 11 and the direction of the optical axis can be detected. In a case where a plurality of imaging devices 11 moves, the relative positional relationship among the plurality of imaging devices 11 can be continuously detected according to the above-described embodiment. However, in a real space where the imaging devices 11 exist, where the imaging devices 11 are located may not be able to be detected.

Therefore, at least one of the plurality of imaging devices 11 is fixed in the real space, and the position information of the other imaging devices 11 is detected using the fixed imaging device 11 as a reference. The position information and an orientation of an optical axis of the fixed imaging device 11 are acquired in advance as the initial position information, and the position information of the other imaging devices 11 is detected with reference to the initial position information, whereby the position information of arbitrary imaging device 11 in the space where the imaging device 11 exists can be detected.

The third embodiment is different from the first and second embodiments in detecting the position information of the other imaging devices 11 with reference to the imaging device 11 fixed in the real space.

The third embodiment can be combined with the first embodiment, and in a case where the third embodiment is combined with the first embodiment, the configuration of the information processing apparatus 12c can be similar to the configuration of the information processing apparatus 12a according to the first embodiment (FIG. 5). Furthermore, the operation of the information processing apparatus 12c according to the third embodiment can be similar to the operation of the information processing apparatus 12a according to the first embodiment (the operation described with reference to the flowchart illustrated in FIG. 6).

However, when the position detection unit 125 detects the position information of the imaging device 11, the reference imaging device 11 is the fixed imaging device 11. For example, in the description of the first embodiment, the description has been given on the assumption that the reference imaging device 11 is the imaging device 11-1. Therefore, processing may just be performed using the imaging device 11-1 as the fixed imaging device 11.

The third embodiment can be combined with the second embodiment, and in a case where the third embodiment is combined with the second embodiment, the configuration of the information processing apparatus 12c can be similar to the configuration of the information processing apparatus 12b according to the second embodiment (FIG. 12).

Furthermore, the operation of the information processing apparatus 12c according to the third embodiment can be similar to the operation of the information processing apparatus 12b according to the second embodiment (the operation described with reference to the flowchart illustrated in FIG. 13).

However, when the position detection unit 125 detects the position information of the imaging device 11, the reference imaging device 11 is the fixed imaging device 11. Even in this case, processing may just be performed using the imaging device 11-1 as the fixed imaging device 11 in the case where the reference imaging device 11 is the imaging device 11-1.

In a case where the processing is performed with reference to the imaging device 11 fixed in the real space in this way, the fixed imaging device 11 may be manually set in advance or may be detected. In a case where the fixed imaging device 11 is detected, the detection can be performed applying a technology used for camera shake of the imaging device 11.

As a method of detecting the fixed imaging device 11 from among a plurality of imaging devices 11, there is a method of dividing an image imaged by the imaging device 11 into a plurality of small regions, and obtaining the moving amount of the small region in a period before and after a certain time by a method such as matching. In a case where most of the field of view of the imaging device is a stationary background, the moving amount of the small region in the period before and after a certain time becomes 0. Meanwhile, in a case where the imaging device 11 is moving or the zoom function is being executed, the imaged background also moves. Therefore, the moving amount of the small region in the period before and after a certain time has a certain value.

In a case where a plurality of images obtained from the plurality of imaging devices 11 are processed and there is an image where the moving amount of the small region in the period before and after a certain time becomes 0, detection is performed using the imaging device 11 that has imaged the image as the fixed imaging device 11.

After the fixed imaging device 11 is detected in this manner, the position information of the other imaging devices 11 is detected using the position of the fixed imaging device 11 as a reference position.

The fixed imaging device 11 may perform a motion such as turning or may execute the zoom function. Even in a case where the fixed imaging device 11 executes turning or the zoom function, the fixed imaging device 11 can be treated as the fixed imaging device 11 in the above-described processing.

In general, the turning and the zoom function of the imaging device 11 is controlled by the imaging device 11, and a turning angle and zooming has reproducibility. Therefore, even if the imaging device 11 performs turning or zooming, the imaging device 11 can return to an initial position (can calculate and set the initial position).

Furthermore, in such a case, the position of the imaging device 11 is unchanged, in other words, the imaging device 11 merely performs the turning or zooming at the initial position and is not away from the initial position. In other words, the position of the imaging device 11 in the space is unchanged due to the tuning or zooming. Therefore, even the fixed imaging device 11 can perform the motion such as turning or zooming without being restricted.

According to the present technology, the position estimation of the imaging device using the physical characteristic points of a person imaged by the plurality of imaging devices can be performed. Furthermore, such position estimation and the position tracking technology of the imaging device can be used together.

Therefore, even in the state where a person is not captured by the imaging device, the position information can be continuously detected by the position tracking technology. Furthermore, when an error occurs in the detection of the position by the position tracking technology, resetting can be performed using the physical characteristic points of a person.

Furthermore, according to the present technology, even in a situation where a plurality of imaging devices is moving, the position information can be detected while following the movement.

### <Recording Medium>

The above-described series of processing can be executed by hardware or software. In the case of executing the series of processing by software, a program that configures the software is installed in a computer. Here, the computer includes a computer incorporated in dedicated hardware, and a general-purpose personal computer and the like capable of executing various functions by installing various programs, for example. A configuration example of hardware of the computer that executes the above-described series of processing by a program can be the information processing apparatus 12 illustrated in FIG. 3. The information processing apparatus 12 (personal computer) performs the above-described series of processing as the CPU 61 loads, for example, a program stored in the storage unit 68 into the RAM 63 and executes the program via the input/output interface 65 and the bus 64.

The program to be executed by the computer (CPU 61) can be recorded on the removable recording medium 71 as a package medium or the like, for example, and provided. Furthermore, the program can be provided via a wired or wireless transmission medium such as a local area network, the Internet, or digital satellite broadcast.

In the computer, the program can be installed to the storage unit 68 via the input/output interface 65 by attaching the removable recording medium 71 to the drive 70. Furthermore, the program can be received by the communication unit 69 via a wired or wireless transmission medium and installed in the storage unit 68. Other than the above method, the program can be installed in the ROM 62 or the storage unit 68 in advance.

Note that the program executed by the computer may be a program processed in chronological order according to the order described in the present specification or may be a program executed in parallel or at necessary timing such as when a call is made.

Furthermore, in the present specification, the system refers to an entire apparatus configured by a plurality of devices.

Note that the effects described in the present specification are merely examples and are not limited, and other effects may be exhibited.

Note that embodiments of the present technology are not limited to the above-described embodiments, and various modifications can be made without departing from the gist of the present technology.

Note that the present technology can also have the following configurations.

(1)

An information processing apparatus including:

a position detection unit configured to detect first position information of a first imaging device and a second imaging device on the basis of a physical characteristic point of a subject imaged by the first imaging device and a physical characteristic point of a subject imaged by a second imaging device; and

a position estimation unit configured to estimate a moving amount of the first imaging device and estimate second position information.

(2)

The information processing apparatus according to (1), in which

the physical characteristic point is detected from a joint of the subject.

(3)

The information processing apparatus according to (2), in which

the joint of the subject is specified by posture estimation processing based on the physical characteristic point detected from the subject.

(4)

The information processing apparatus according to any one of (1) to (3), in which

the subject is a person.

(5)

The information processing apparatus according to any one of (1) to (4), in which

the position estimation unit estimates the second position information of the first imaging device from a moving amount of a characteristic point included in images detected on the basis of the images imaged by the first imaging device at different times.

(6)

The information processing apparatus according to any one of (1) to (5), in which the position estimation unit estimates the second position information of the first imaging device by simultaneous localization and mapping (SLAM).

(7)

The information processing apparatus according to any one of (1) to (6), further including:

a position integration unit configured to integrate the first position information detected by the position detection unit and the second position information estimated by the position estimation unit to specify positions of the first imaging device and the second imaging device in a case where the first imaging device is moving.

(8)

The information processing apparatus according to (7), in which

the position integration unit specifies the positions of the first imaging device and the second imaging device on the basis of the first position information detected by the position detection unit, and the position estimation unit initializes the estimated second position information on the basis of the first position information detected by the position detection unit, in a case where the first imaging device and the second imaging device are stationary.

(9)

The information processing apparatus according to (7), in which

the position integration unit specifies the positions of the first imaging device and the second imaging device on the basis of the first position information detected by the position detection unit, in a case where the first imaging device or the second imaging device is executing a zoom function.

(10)

The information processing apparatus according to (7), in which

the position integration unit performs weighting calculation using a coefficient calculated from the number of characteristic points used for detecting the first position information by the position detection unit and the number of characteristic points used for estimating the second position information by the position estimation unit.

(11)

The information processing apparatus according to (7), in which

the position detection unit detects the first position information of the first imaging device and the second imaging device in a case where the subject imaged by the first imaging device coincides with the subject imaged by the second imaging device, and

the position integration unit specifies the positions of the first imaging device and the second imaging device on the basis of the second position information estimated by the position estimation unit in a case where the first position information is not detected by the position detection unit.

(12)

The information processing apparatus according to any one of (1) to (11), in which

the position estimation unit acquires movement information of the first imaging device and estimates the second position information of the first imaging device, using the movement information.

(13)

The information processing apparatus according to (12), in which

the movement information is obtained on the basis of measurement by an inertial measurement unit attached to the first imaging device.

(14)

The information processing apparatus according to (13), in which

the inertial measurement unit includes a triaxial gyro and a three-directional accelerometer and

the movement information is a three-directional angular velocity and acceleration.

(15)

The information processing apparatus according to (12), further including:

a position integration unit configured to integrate the first position information detected by the position detection unit and the second position information estimated by the position estimation unit, in which the position detection unit detects the first position information of the first imaging device and the second imaging device, in a case where the subject imaged by the first imaging device and the subject imaged by the second imaging device are a same person, and

the position integration unit integrates the first position information detected by the position detection unit and the second position information estimated by the position estimation unit to specify positions of the first imaging device and the second imaging device, in a case where the first position information is detected by the position detection unit, and specifies positions of the first imaging device and the second imaging device on the basis of the second position information estimated by the position estimation unit, in a case where the first position information is not detected by the position detection unit.

(16)

The information processing apparatus according to (1), in which,

in a case where a position of at least one imaging device out of a plurality of imaging devices is fixed in a real space, the position detection unit detects position information of another imaging device, using the position of the imaging device, the position being fixed in the real space, as a reference.

(17)

The information processing apparatus according to (1), in which

the position information detected by the position detection unit is smoothed in a time direction.

(18)

The information processing apparatus according to (1), in which

the position detection unit verifies the detected position information, using a characteristic point other than the characteristic points used for the position detection.

(19)

An information processing method including:

by an information processing apparatus that detects a position of an imaging device,

detecting first position information of a first imaging device and a second imaging device on the basis of a physical characteristic point of a subject imaged by the first imaging device and a physical characteristic point of a subject imaged by a second imaging device; and

estimating a moving amount of the first imaging device and estimating second position information.

(20)

A program for causing a computer to execute processing of:

detecting first position information of a first imaging device and a second imaging device on the basis of a physical characteristic point of a subject imaged by the first imaging device and a physical characteristic point of a subject imaged by a second imaging device; and

estimating a moving amount of the first imaging device and estimating second position information.

### REFERENCE SIGNS LIST

11 Imaging device
12 Information processing apparatus
31 Lens system
32 Imaging element
33 DSP circuit
34 Frame memory
35 Display unit
36 Recording unit
37 Operation system
38 Power supply system
39 Communication unit
40 Bus line
41 CPU
61 CPU
62 ROM
63 RAM
64 Bus
65 Input/output interface
66 Input unit
67 Output unit
68 Storage unit
69 Communication unit
70 Drive
71 Removable recording medium
101 Imaging unit
102 Communication control unit
121 Image input unit
122 Person detection unit
123 Same person determination unit
124 Characteristic point detection unit
125 Position detection unit
126 Position integration unit
127 Position tracking unit
201 Measurement result input unit
202 Position tracking unit
203 Position integration unit

1. An information processing apparatus comprising:
position detection circuitry configured to detect a first position information of a first imaging device and a second imaging device on a basis of a physical characteristic point of a subject imaged by the first imaging device and a physical characteristic point of a subject imaged by a second imaging device; and
position estimation circuitry configured to estimate a moving amount of at least one of the first imaging device or the second imaging device, and to estimate a second position information of the first imaging device and the second imaging device on a basis of the first position information and the moving amount.

2. The information processing apparatus according to claim 1, wherein
the physical characteristic point is detected from a joint of the subject.

3. The information processing apparatus according to claim 2, wherein
the joint of the subject is specified by posture estimation processing based on the physical characteristic point detected from the subject.

4. The information processing apparatus according to claim 1, wherein
the subject is a person.

5. The information processing apparatus according to claim 1, wherein
the position estimation circuitry estimates the second position information of the first imaging device from a moving amount of a characteristic point included in images imaged by the first imaging device at different times.

6. The information processing apparatus according to claim 1, wherein
the position estimation circuitry estimates the second position information of the first imaging device by simultaneous localization and mapping (SLAM).

7. The information processing apparatus according to claim 1, further comprising:
position integration circuitry configured to integrate the first position information detected by the position detection circuitry and the second position information estimated by the position estimation circuitry to specify positions of the first imaging device and the second imaging device in a case where the first imaging device is moving.

8. The information processing apparatus according to claim 7, wherein
the position integration circuitry specifies respective positions of the first imaging device and the second imaging device on a basis of the first position information detected by the position detection circuitry, and the position estimation circuitry initializes the estimated second position information on a basis of the first position information detected by the position detection circuitry, in a case where the first imaging device and the second imaging device are stationary.

9. The information processing apparatus according to claim 7, wherein
the position integration circuitry specifies respective positions of the first imaging device and the second imaging device on a basis of the first position information detected by the position detection circuitry, in a case where the first imaging device or the second imaging device is executing a zoom function.

10. The information processing apparatus according to claim 7, wherein
the position integration circuitry performs a weighting calculation using a coefficient calculated from the number of characteristic points used for detecting the first position information by the position detection circuitry and the number of characteristic points used for estimating the second position information by the position estimation circuitry.

11. The information processing apparatus according to claim 7, wherein
the position detection circuitry detects the first position information of the first imaging device and the second imaging device in a case where the subject imaged by the first imaging device coincides with the subject imaged by the second imaging device, and
the position integration circuitry specifies respective positions of the first imaging device and the second imaging device on a basis of the second position information estimated by the position estimation circuitry in a case where the first position information is not detected by the position detection circuitry.

12. The information processing apparatus according to claim 1, wherein
the position estimation circuitry acquires a movement information of the first imaging device and estimates the second position information of the first imaging device, using the movement information.

13. The information processing apparatus according to claim 12, wherein
the movement information is obtained on a basis of measurement by an inertial measurement sensor attached to the first imaging device.

14. The information processing apparatus according to claim 13, wherein
the inertial measurement sensor includes a triaxial gyro and a three-directional accelerometer, and
the movement information is a three-directional angular velocity and acceleration.

15. The information processing apparatus according to claim 12, further comprising:
position integration circuitry configured to integrate the first position information detected by the position detection circuitry and the second position information estimated by the position estimation circuitry, wherein
the position detection circuitry detects the first position information of the first imaging device and the second imaging device, in a case where the subject imaged by the first imaging device and the subject imaged by the second imaging device are a same person, and
the position integration circuitry integrates the first position information detected by the position detection circuitry and the second position information estimated by the position estimation circuitry to specify positions of the first imaging device and the second imaging device, in a case where the first position information is detected by the position detection circuitry, and specifies positions of the first imaging device and the second imaging device on a basis of the second position information estimated by the position estimation circuitry, in a case where the first position information is not detected by the position detection circuitry.

16. The information processing apparatus according to claim 1, wherein,
in a case where a position of at least one imaging device out of a plurality of imaging devices including the first imaging device and the second imaging device is fixed in a real space, the position detection circuitry detects a first position information of another imaging device, using the position of the imaging device, the position being fixed in the real space, as a reference.

17. The information processing apparatus according to claim 1, wherein
the first position information detected by the position detection unit circuitry is smoothed in a time direction.

18. The information processing apparatus according to claim 1, wherein
the position detection circuitry verifies the detected position information, using a characteristic point other than the characteristic points used for the position detection.

19. An information processing method comprising:
by an information processing apparatus that detects a position of an imaging device,
detecting a first position information of a first imaging device and a second imaging device on a basis of a physical characteristic point of a subject imaged by the first imaging device and a physical characteristic point of a subject imaged by a second imaging device; and
estimating a moving amount of at least one of the first imaging device or the second imaging device, and estimating a second position information of the first imaging device and the second imaging device on a basis of the first position information and the moving amount.

20. A non-transitory computer-readable medium storing instructions that, when executed by a processor of a computer, cause the computer to execute operations comprising:
detecting a first position information of a first imaging device and a second imaging device on a basis of a physical characteristic point of a subject imaged by the first imaging device and a physical characteristic point of a subject imaged by a second imaging device; and
estimating a moving amount of at least one of the first imaging device or the second imaging device, and estimating a second position information of the first imaging device and the second imaging device on a basis of the first position information and the moving amount.
